(19) United States
(12) Patent Application Publication
(10) Pub. No.: US 2025/0097180 A1
(43) Pub. Date: Mar. 20, 2025

(54) METHOD FOR OPTIMIZING TRAFFIC OVER CONSTRAINED NETWORKS

(71) Applicant: ITRON, INC., Liberty Lake, WA (US)

(72) Inventor: Carter TIMM, Spokane, WA (US)

(21) Appl. No.: 18/469,226

(22) Filed: Sep. 18, 2023

(51) Int. Cl. H04L 51/10; H04L 51/58

(52) U.S. Cl. CPC H04L 51/10; H04L 51/58

(57) ABSTRACT

Various embodiments disclose a method comprising establishing, at a first node, a connection with an access point and transmitting, by the first node to a control device, a first message that identifies the access point. The method further comprises receiving, by the first node from the control device, a second message that includes a number of nodes connected to the access point and determining, by the first node, an operating parameter of the first node based on the number of nodes connected to the access point. The method further comprises transmitting, by the first node to the control device and based on the operating parameter, a third message. Alternatively, the method includes the control device determining the operating parameter based on the number of nodes connected to the access point and sending the operating parameter to the first node.

### BACKGROUND

### Field of the Various Embodiments

The various embodiments relate generally to communication networks, and more specifically, to optimizing traffic over constrained networks.

### Description of the Related Art

Many networks, such as low-power wide area networks (LPWANs) and some cellular networks operate as constrained networks where individual base stations and/or access points can receive only a limited number of messages or packets during a defined time period. For example, in cellular networks, a cellular base station provides network coverage in the form of one or more cell sectors emanating from one or more sector antennas located at the cellular base station. A first cell sector emanating in a first direction from a first sector antenna provides network coverage to one or more nodes that are located in the first direction relative to the cellular base station. Similarly, a second cell sector emanating in a second direction from a second sector antenna provides network coverage to one or more nodes that are located in the second direction relative to the cellular base station and a third cell sector emanating in a third direction from a third sector antenna provides network coverage to one or more nodes that are located in the third direction relative to the cellular base station. A Cat-M1 network is one example of a constrained network in which a sector antenna can receive only a limited number of packets per second (e.g., five packets per second) from nodes connected to the sector antenna. As another example, an NB-IoT network is a type of constrained network in which a sector antenna can receive only a limited number of packets per second (e.g., one packet per second) from nodes connected to the sector antenna.

### BRIEF DESCRIPTION OF THE DRAWINGS

So that the manner in which the features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an example flow diagram showing a process for optimizing traffic over a constrained network, according to various embodiments;

FIG. 2 illustrates a node device, according to various embodiments;

FIG. 3 illustrates an example configuration table that is used to determine one or more operating parameters of a node device, according to various embodiments;

FIG. 4 is a graph illustrating success rates of message transmissions in a constrained network, according to various embodiments.

FIG. 5 illustrates an example configuration table that is used to determine one or more operating parameters of a node device, according to various embodiments;

FIG. 6 is a graph illustrating success rates of message transmissions in a constrained network, according to various embodiments.

FIG. 7 illustrates an example configuration table that is used to determine one or more operating parameters of a node device, according to various embodiments.

FIG. 8 is a graph illustrating amounts of time taken for node devices to register with a control device in a constrained network, according to various other embodiments.

FIG. 9 illustrates a control device, according to various embodiments;

FIG. 10 is a flow diagram of method steps for optimizing traffic over a constrained network, according to various embodiments.

FIG. 11 is a flow diagram of method steps for optimizing traffic over a constrained network, according to various embodiments.

FIG. 12 is a flow diagram of method steps for registering with a control device in a constrained network, according to various embodiments.

FIG. 13 illustrates a network system, configured to implement one or more aspects of the various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

In many constrained network architectures, a node connects to a sector antenna or other access point to transmit messages over the network. At a given time, many nodes (e.g., 250, 500, etc.) in the network can be connected to the same access point. In some instances, many nodes might attempt to transmit a message, which comprises one or more packets, to a device in the network via the same access point at or near the same time. However, the number of packets that can be received at a particular access point during a defined time period is limited in a constrained network. Accordingly, for instances in which many nodes attempt to transmit a message via the same access point at or near the same time, the access point is not capable of receiving all of the transmitted messages, and thus, many of the message transmissions fail.

One instance in which many nodes might attempt to transmit a message via the same access point at or near the same time is during a power outage. For example, when a power outage occurs, a node that is powered by mains-power has a limited time window (e.g., 90 seconds) within which the node can transmit a message before the node exhausts its back-up power source. Accordingly, during the limited time window, a first node attempts to transmit a power-outage notification (PON), via the access point, to a control device (e.g., a server in a control center or at a headend) to indicate that the first node will be offline until mains-power is restored. However, if many other nodes connected to the access point are attempting to transmit PONs at or near the same time as the first node, many of the PON transmissions will fail due to the constraints of the access point.

Another instance in which many nodes might attempt to transmit a message via the same access point at or near the same time is during a power restoration event. For example, when power is restored after a power outage, a first node that is powered by mains-power turns on and transmits, via an access point, a message to reconnect, or register, with the access point and/or a control device. However, if many other nodes are attempting to transmit, via the same access point, messages to register with the access point and/or the control device at or near the same time as the first node, transmission of many of the registration messages will fail due to the constraints of the access point.

In some conventional constrained networks, a node might be configured to transmit a message multiple times (e.g., a fixed or a random number of times) in an attempt to increase the chance of successfully transmitting the message. A drawback to this approach, however, is that the effectiveness of a number of message transmissions can change depending on how many nodes are connected to the same access point at a given time. For example, when relatively few nodes (e.g., 100) are connected to the same access point, transmitting a message relatively many times (e.g., 5 times) can increase the likelihood of successfully transmitting the message. However, when relatively many nodes (e.g., 500) are connected to the same access point, the likelihood of successfully transmitting a message can decrease significantly if a node attempts to transmit the message relatively many times (e.g., 5 times) because of the numerous collisions between the messages transmitted by the many nodes. Accordingly, with this approach, a node might select a number of times to transmit a message that decreases, not increases, the likelihood of successfully transmitting the message.

In other conventional constrained networks, a node might be configured to transmit a message at a random time within a time window of a randomized length. A drawback to this approach, however, is that the effectiveness of the length of the time window within which the node transmits a message can change depending on how many nodes are connected to an access point at a given time. For example, when relatively few nodes (e.g., 250) are connected to the same access point, an amount of time taken for multiple nodes to successfully transmit a message can be greatly reduced when the nodes transmit messages within time windows that are a particular duration (e.g., 1.5 minutes long) because fewer collisions between messages occur. However, when relatively many nodes (e.g., 1000) are connected to the same access point, if multiple nodes connected to the same access point transmit messages within a time window that is the same duration (e.g., 1.5 minutes long), the amount of time it takes for the nodes to successfully transmit messages greatly increases because more collisions between messages occur. Accordingly, with this approach, nodes might select a random time window length that increases, not decreases, the amount of time it takes for multiple nodes to successfully transmit a message.

In order to address these shortcomings, techniques are disclosed herein that enable a node to adjust its transmission behavior based on a number of nodes that are connected to a sector antenna or other access point. In various embodiments, a node establishes a connection with an access point and transmits, to a control device, a message that indicates the node is connected to the access point. Further, the node can determine how many other nodes are connected to the access point. For example, the node can determine, based on a message received from the control device, the number of nodes that are connected to the access point. In some embodiments, the node determines an operating parameter based on the number of nodes that are connected to the access point. For example, the node can determine an operating parameter indicating a number of times to transmit a message based on the number of nodes that are connected to the access point. As another example, the node can determine an operating parameter indicating a length of a time window within which the node transmits a message based on the number of nodes that are connected to the access point. After determining the operating parameter based on the number of nodes that are connected to the access point, the node transmits one or more messages in accordance with the operating parameter.

At least one technical advantage of the disclosed techniques is that the disclosed techniques improve the ability of nodes to transmit messages over a constrained network during time periods when many nodes are likely to be transmitting messages. For example, the disclosed techniques increase the likelihood that a node can successfully transmit a message over a constrained network. As another example, the disclosed techniques reduce the amount of time it takes for all nodes to successfully transmit a message over a constrained network.

### Optimizing Traffic in a Constrained Network

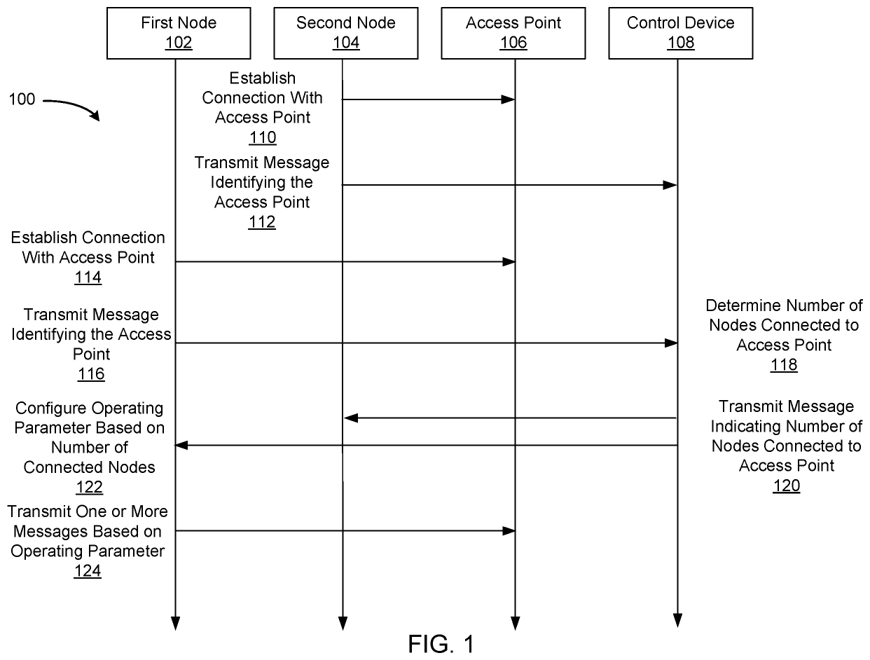

FIG. 1 illustrates an example flow diagram showing process 100 for optimizing traffic in a constrained network, according to various embodiments. Although the interactions between the devices in process 100 are shown in an order, persons skilled in the art will understand that the interactions may be performed in a different order, interactions may be repeated or skipped, and/or may be performed by components other than those described in FIG. 1.

As shown in FIG. 1, process 100 involves various operations performed by, without limitation, first node 102, second node 104, access point 106, and control device 108. Nodes 102 and 104 are connected to control device 108 by a network such as a cellular network, a low-power wide area network (LPWAN), or some other type of constrained network. First node 102 and second node 104 can communicate with control device 108 and/or other devices in the network via access point 106. For example, first node 102 establishes a connection with access point 106 to transmit messages to and/or receive messages from control device 108 over the network. Similarly, second node 104 establishes a connection with access point 106 to transmit messages to and/or receive messages from control device 108 over the network. In some examples, first and second node 104 can communicate directly with each other. Although only first and second nodes 102, 104 are illustrated in FIG. 1, persons skilled in the art will understand that many other nodes can be connected to the network to which first and second nodes 102, 104 are connected.

As used herein, the term access point 106 refers to a device that enables nodes, such as first node 102 and second node 104, to transmit messages to and/or receive messages from devices, such as control device 108, in a network. For example, first node 102 and/or second node 104 connect to access point 106 to transmit messages to control device 108 or other devices in the network. Similarly, first node 102 and/or second node 104 connect to access point 106 to receive messages from control device 108 or other devices in the network located upstream of access point 106.

In some embodiments, access point 106 is implemented as a sector antenna located at a cellular base station. A sector antenna provides network coverage in the form of a cell sector that emanates from the sector antenna in a direction relative to the cellular base station. In some examples, a cellular base station includes three sector antennas. In such examples, a first one of the sector antennas provides network coverage spanning an arc of 120 degrees in a first direction relative to the cellular base station, a second one of the sector antennas provides network coverage that spans an arc of 120 degrees in a second direction relative to the cellular base station, and a third one of the sector antennas provides network coverage that spans an arc of 120 degrees in a third direction relative to the cellular base station. In other examples, the cellular base station includes a different number of sector antennas, such as four sector antennas, six sector antennas, or some other number of sector antennas. In some embodiments, access point 106 is implemented as one or more of a wireless access point, a router, a gateway, a transceiver, or some other type of network device that enables nodes to connect to devices in the network located upstream of access point 106. In some embodiments, another node can be implemented as an access point, such as access point 106.

As shown, process 100 begins at step 110, in which second node 104 establishes a connection with access point 106. For example, establishing a connection with access point 106 can include establishing a wireless communication link between second node 104 and access point 106. When second node 104 is connected to access point 106, second node 104 can transmit messages to and/or receive messages from other devices in the network, such as control device 108, via access point 106. For example, second node 104 transmits a message over the communication link with access point 106 and access point 106 then routes, or directs, the message to a device in the network.

At step 112, second node 104 transmits, via access point 106, a message to control device 108 that identifies access point 106. For example, the message indicates that second node 104 is connected to access point 106 and/or includes a unique identifier associated with access point 106.

At step 114, first node 102 establishes a connection with access point 106. For example, establishing a connection with access point 106 can include establishing a wireless communication link between first node 102 and access point 106. When first node 102 is connected to access point 106, first node 102 can transmit messages to and/or receive messages from other devices in the network, such as control device 108, via access point 106. For example, first node 102 transmits a message over the communication link with access point 106 and access point 106 then routes, or directs, the message to a device in the network.

At step 116, first node 102 transmits, via access point 106, a message to control device 108 that identifies access point 106. For example, the message indicates that first node 102 is connected to access point 106 and/or includes a unique identifier associated with access point 106.

At a given time, many nodes (e.g., 250, 500, 1000, 10,000, or more) in the network can be connected to access point 106. As described above, a node is connected to an access point 106 when a wireless communication link between the node and access point 106 is established. At step 118, control device 108 determines a number of nodes that are connected to, or in wireless communication with, access point 106. For example, control device 108 determines, based on messages identifying access point 106 that are received from a plurality of nodes connected to access point 106 (e.g., first node 102, second node 104, and/or other nodes), the number of nodes that are connected to access point 106. In some examples, control device 108 maintains a list of nodes that are connected to access point 106. In such examples, when control device 108 receives a message from a new node that indicates the new node is connected to access point 106, control device adds the new node to a list of nodes connected to access point 106. In some examples, control device 108 removes a respective node from the list of nodes connected to access point 106 when the respective node connects to a different access point and/or when the control device 108 has not received a message from the respective node for a particular amount of time (e.g., a few days, 1 week, 1 month, 3 months, etc.). In some examples, control device 108 removes a respective node from the list of nodes connected to access point 106 in response to receiving a message, such as a PON, from the respective node that indicates the respective node will disconnect from access point 106.

At step 120, control device 108 transmits, via access point 106, one or more messages that include information to one or more nodes connected to access point 106. The information includes and/or indicates the number of nodes connected to access point 106 to one or more nodes connected to access point 106. For example, as shown in FIG. 1, control device 108 transmits a message to second node 104 that indicates the number of nodes connected to access point 106 and transmits a message to first node 102 that indicates the number of nodes connected to access point 106. In some examples, control device 108 transmits one or more messages that indicate the number of nodes connected to access point 106 periodically and/or on an ad-hoc basis. As will be described in more detail below, in some examples, the information further includes one or more operating parameters for first node 102 and/or second node 104.

In operation, access point 106 can only receive a limited number of messages or packets during a defined time period. For example, if access point 106 is a sector antenna in a Cat-M1 network, access point 106 can only receive a certain number of packets (e.g., five packets) per second from nodes transmitting messages. Persons skilled in the art will understand that five packets per second is a non-limiting example of the number of packets per second by an access point in a Cat-M1 network, and that in other examples, a different number of packets per second can be received by an access point in a Cat-M1 network. As another example, if access point 106 is a sector antenna in an NB-IoT network, access point 106 can only receive a different certain number of packets (e.g., one packet) per second from nodes transmitting messages. Persons skilled in the art will understand that one packet per second is a non-limiting example of the number of packets per second by an access point in an NB-IoT network, and that in other examples, a different number of packets per second can be received by an access point in an NB-IoT network. Thus, when multiple nodes connected to access point 106 attempt to transmit messages via access point 106 at or near the same time, collisions between the messages transmitted by the nodes can result in failure to successfully transmit all messages. To minimize these transmission failures, nodes connected to access point 106 can adjust their transmission behavior to reduce the probability of transmitting messages that collide with messages transmitted by other nodes based on the number of nodes connected to access point 106. For example, based on the number of nodes connected to access point 106, a node can adjust one or more operating parameters of the node to increase the chances of successfully transmitting the message. The one or more operating parameters of the node can include a number of times that the node transmits a message and/or a length of a transmission window during which the node randomly transmits the message.

Accordingly, at step 122, first node 102 receives the message that includes the information indicative of the number of nodes connected to access point 106 and determines, or adjusts, one or more of its operating parameters based on the number of nodes connected to access point 106. The one or more operating parameters of first node 102 can include a number of times (e.g., 0.3, 1.0, 1.1, 2.0, 2.48753, 3, 4, etc.) that first node 102 transmits a message. For example, based on the number of nodes connected to access point 106, first node 102 determines how many times it should transmit a message to achieve the greatest chance of successfully transmitting the message. The one or more operating parameters of first node 102 can also include a length, or duration, of a transmission window during which first node 102 randomly transmits a message. For example, based on the number of nodes connected to access point 106, first node 102 determines a transmission window length that results in the greatest chance of successfully transmitting a message and/or reduces an amount of time taken by first node 102 to successfully transmit a message. In some examples, if first node 102 does not receive a message that indicates the number of nodes connected to access point 106, first node 102 can determine one or more of its operating parameters based on a number of nodes connected to access point 106 that was previously determined and/or stored in storage of first node 102.

First node 102 can store one or more configuration tables, equations, and/or algorithms that are used for determining an operating parameter of first node 102 based on the number of nodes connected to access point 106. For example, first node 102 can store a configuration table that indicates how many times first node 102 should transmit a message for various numbers of nodes connected to access point 106. In this example, first node 102 determines, using the configuration table, the number of times first node 102 should transmit a message based on the number of nodes connected to access point 106. As another example, first node 102 can store a configuration table that indicates the length, or duration, of a transmission window during which first node 102 should randomly transmit a message for various numbers of nodes connected to access point 106. In this example, first node 102 determines, using the configuration table, the length of the transmission window during which first node 102 should randomly transmit a message based on the number of nodes connected to access point 106.

In some examples, the configuration table indicates a respective number of times that first node 102 should transmit a message for various numbers of nodes connected to access point 106 within a range of possible numbers of nodes connected to access point 106. For example, the configuration table can indicate a respective number of times that first node 102 should transmit a message for every number of nodes connected to access point 106 within a range from a minimum number of nodes connected to access point 106 (e.g., 1 node) to a maximum number of nodes connected to access point 106 (e.g., 10,000 nodes, 20,000 nodes, etc.). In some examples, the configuration table indicates that first node 102 should transmit a message a first number of times when the number of nodes connected to access point 106 is within a first range (e.g., less than 100 nodes), indicate that first node 102 should transmit a message a second number of times when the number of nodes connected to access point 106 is within a second range (e.g., between 100 and 200 nodes), and so on. In some examples, when the exact number of nodes connected to access point 106 is not included in the configuration table, first node 102 can determine how many times to transmit a message by interpolating between values in the configuration table that correspond to numbers of nodes connected to access point 106 that are similar to the actual number of nodes connected to access point 106. For example, if 273 nodes are connected to access point 106, first node 102 can determine how many times to transmit a message by interpolating between the number of times to transmit a message when 250 nodes connected to access point 106 and the number of times to transmit a message when 300 nodes connected to access point 106.

In some examples, the configuration table indicates a respective length of a transmission window for various numbers of nodes connected to access point 106 within a range of possible numbers of nodes connected to access point 106. For example, the configuration table can indicate a respective length of a transmission window that should be used by every number of nodes connected to access point 106 within a range from a minimum number of nodes connected to access point 106 (e.g., 1 node) to a maximum number of nodes connected to access point 106 (e.g., 10,000 nodes, 20,000 nodes, etc.). In some examples, the configuration table indicates that first node 102 should use a transmission window of a first length when the number of nodes connected to access point 106 is within a first range (e.g., less than 100 nodes), indicate that first node 102 should use a transmission window of a second length when the number of nodes connected to access point 106 is within a second range (e.g., between 100 and 200 nodes), and so on. In some examples, when the exact number of nodes connected to access point 106 is not included in the configuration table, first node 102 can determine the length of the transmission window by interpolating between the values in the configuration table that correspond to numbers of nodes connected to access point 106 that are close to the actual number of nodes connected to access point 106. For example, if 273 nodes are connected to access point 106, first node 102 can determine the length of the transmission window by interpolating between the value of the transmission window length when 250 nodes are connected to access point 106 and the value of the transmission window length when 300 nodes connected to access point 106.

In some examples, first node 102 can communicate via different types of networks. For example, first node 102 can connect to a first access point to communicate with devices in a first type of network (e.g., Cat-M1) and connect to a second access point to communicate with devices in a second type of network (e.g., NB-IoT). In such examples, the first access point can receive a number of packets per period of time that is different than the number of packets per period of time that can be received by the second access point. To account for differences between the constraints of the first and second access points, first node 102 can store a first set of one or more configuration tables that are used to determine one or more operating parameters of first node 102 when first node 102 is connected to the first access point and/or communicating with devices in the first type of network. Furthermore, first node 102 can store a second set of one or more configuration tables that are used to determine one or more operating parameters of first node 102 when first node 102 is connected to the second access point and/or communicating with devices in the second type of network. Accordingly, first node 102 can determine which configuration table(s) to use for determining one or more operating parameters of first node 102 based on the type of access point and/or network to which first node 102 is connected.

In some examples, first node 102 stores one or more equations and/or algorithms that are used for determining a respective number of times first node 102 should transmit a message based on a number of nodes connected to access point 106. In this example, the number of nodes connected to access point 106 can be provided as an input to the one or more equations and/or algorithms, and the one or more equations and/or algorithms output the number of times first node 102 should transmit a message. As another example, first node 102 can store one or more equations and/or algorithms that are used for determining the length, or duration, of a transmission window during which first node 102 should randomly transmit a message based on a number of nodes connected to access point 106. In this example, the number of nodes connected to access point 106 can be provided as an input to the one or more equations and/or algorithms, and the one or more equations and/or algorithms output the length, or duration, of a transmission window during which first node 102 should randomly transmit a message.

Referring back to step 120, in some alternative examples, control device 108 determines one or more operating parameters of first node 102 and/or second node 104 based on the number of nodes connected to access point 106. In such examples, the information included in a message transmitted by the control device 108 to first node 102 at step 120 includes one or more operating parameters of first node 102. Further, in such examples, the information included in a message transmitted by the control device 108 to second node 104 at step 120 includes one or more operating parameters of second node 104. Then, at step 122, first node 102 receives the message that includes one or more operating parameters from control device 108 and configures its operating parameters based on the one or more operating parameters included in the message.

At step 124, first node 102 transmits, via access point 106, one or more messages to control device 108 in accordance with the operating parameter(s) of first node 102 that were determined at step 122. For example, first node 102 transmits, via access point 106, one or more messages to control device 108 the number of times that was determined at step 122. As another example, first node 102 transmits, via access point 106, a message to control device 108 at a random time within a transmission window of the length that was determined at step 122. In some embodiments, first node 102 transmits the one or more messages to control device 108 in accordance with the operating parameter(s) that were configured at step 122 on a periodic and/or ad-hoc basis. For example, first node 102 transmits, via access point 106, one or more messages indicative of a status of first node 102 to control device 108 once per day, once per week, or at some other interval. In some embodiments, first node 102 transmits one or more messages in accordance with the operating parameter(s) that were configured at step 122 in response to the occurrence of a trigger event.

In some examples, first node 102 transmits, via access point 106, one or more messages in accordance with operating parameter(s) determined at step 122 to control device 108 in response to determining that a power outage has occurred and a power supply (e.g., mains-power and/or battery power) of first node 102 is disconnected from mains-power and/or depleted. As an example, it will be assumed that 500 nodes are connected to access point 106 and, at step 122, first node 102 determines, using a configuration table, an equation, and/or an algorithm stored in a memory of first node 102, to transmit a message two times when 500 nodes are connected to access point 106. In this example, at step 124, first node 102 transmits, via access point 106, a power outage notification (PON) to control device 108 two times in response to determining that that a power outage has occurred.

In some examples, first node 102 transmits, via access point 106, one or more messages in accordance with operating parameter(s) determined at step 122 to control device 108 in response to determining that power has been restored after a power outage has occurred and/or a battery in first node 102 has been recharged to at least a minimum charge threshold. As an example, it will be assumed that 500 nodes are connected to access point 106 and, at step 122, first node 102 determines, using a configuration table, an equation, and/or an algorithm stored in a memory of first node 102, to use a transmission window that is two minutes long when 500 nodes are connected to access point 106. In this example, at step 124, first node 102 transmits, via access point 106, a power restoration notification (PRN) to control device 108 at a random time within a two minute long transmission window in response to determining that power has been restored after a power outage.

In some examples, in response to determining that power has been restored after a power outage has occurred, first node 102 transmits, in accordance with the operating parameter(s) determined at step 122, one or more messages to access point 106 to reconnect, or register, with access point 106 after power has been restored. In such examples, in response to determining that power has been restored after a power outage occurred, first node 102 transmits a message to access point 106 at a random time within a transmission window of a length that was determined at step 120 and/or step 122.

### Node Device

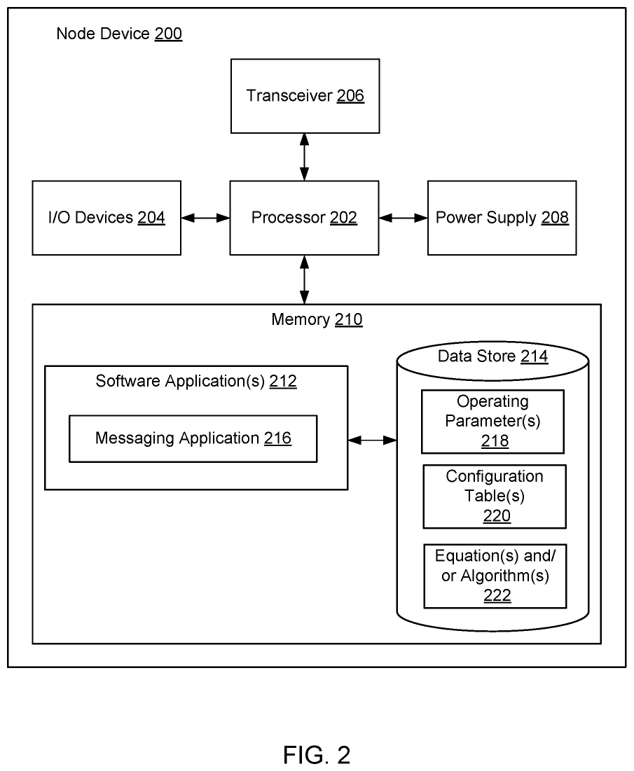

FIG. 2 illustrates a node device 200, according to various embodiments. Node device 200 can be any communication device that communicates with devices in a network via an access point, such as access point 106. In one example, node device 200 is a utility metering device that is coupled to, or included within, a utility distribution infrastructure in which node device 200 monitors consumption of a utility commodity (e.g., water, gas, electricity, etc.). In some embodiments, node device 200 is used to implement any of first node 102 or second node 104 of FIG. 1. As shown, node device 200 includes, without limitation, processor 202, input/output (I/O) devices 204, transceiver 206, power supply 208, and memory 210, coupled together.

Processor 202 coordinates operations of node device 200. In various embodiments, processor 202 includes any hardware configured to process data and execute software applications. The processor 202 can be any technically feasible processing device configured to process data and execute program instructions. For example, processor 202 could include one or more central processing units (CPUs), DSPs, graphics processing units (GPUs), application-specific integrated circuits (ASICs), field-programmable gate arrays (FPGAs), microprocessors, microcontrollers, other types of processing units, and/or a combination of different processing units. Processor 202 can include a real-time clock (RTC) (not shown) according to which processor 202 maintains an estimate of the current time. The estimate of the current time can be expressed in Universal Coordinated Time (UTC), although any other standard of time measurement can also be used.

I/O devices 204 include devices configured to receive input, devices configured to provide output, and devices configured to both receive input and provide output. As described above, in some examples, node device 200 is a utility metering device that is coupled to, or included within, a utility distribution infrastructure. In this example, I/O devices 204 can further include one or more data acquisition devices that are used by node device 200 to monitor consumption of a utility commodity (e.g., water, gas, electricity, etc.). For example, I/O devices 204 can further include one or more of an electricity meter, a gas meter, a water meter, or some other type of sensor used to monitor consumption of a utility commodity.

Transceiver 206 is configured to transmit messages to and/or receive messages from other devices in the network (e.g., node devices 200, first node 102, second node 104, access point 106, or control device 108) via an access point (e.g., access point 106). Transceiver 206 can be implemented as any suitable transmission and/or reception device. In some examples, transceiver 206 can operate in a first communication mode in which transceiver 206 communicates with one or more devices in a first type of network and can operate in a second communication mode in which transceiver 206 communicates with one or more devices in a second type of network. For example, while in the first communication mode, transceiver 206 transmits messages to and/or receives messages from devices in a first type of network (e.g., Cat-M1 network) via a first type of access point. As another example, while in the second communication mode, transceiver 206 transmits messages to and/or receives messages from devices in a second type of network (e.g., NB-IoT network) via a second type of access point. In operation, transceiver 206 can transition between communication modes. In some examples, transceiver 206 can operate in more than two communication modes and/or communicate with devices in more than two different types of networks.

Power supply 208 provides power to one or more of the components included in node device 200. For example, power supply 208 powers one or more of processor 202, I/O devices 204, transceiver 206, and memory 210. In some examples, power supply 208 is connected to mains-power such that power supply 208 powers one or more components of node device 200 with mains-power. In some examples, power supply 208 includes a battery that is used to provide power to one or more components of node device 200.

Memory 210 includes one or more software applications 212 and a data store 214, coupled together. As shown, the one or more software applications 212 include messaging application 216. Data store 214 stores one or more operating parameters 218 of node device 200, one or more configuration tables 220 that are used for determining the one or more operating parameters 218, and/or one or more equations and/or algorithms 222 used for determining the one or more operating parameters 218. As described above with respect to FIG. 1, one or more operating parameters 218 can include a number of times that node device 200 transmits a message, a length of a transmission window during which node device 200 randomly transmits a message, and/or some other parameter associated with the transmission behavior of node device 200. In some examples, the one or more operating parameters 218 also include the number of nodes connected to the access point (e.g., access point 106) to which node device 200 is connected and/or the number of nodes that were connected to an access point to which node device 200 was previously connected. As will be described in more detail herein, in some examples, values of the one or more operating parameters 218 can be determined by and received from a control device (e.g., control device 108).

The one or more configuration table 220 can include values of operating parameter(s) 218 to be used by node device 200 for various numbers of node devices connected to the same access point as node device 200. For example, configuration table(s) 220 can include values for transmission attempts, or how many times node device 200 transmits a message, for various numbers of node devices connected to the same access point as node device 200. As another example, configuration table(s) 220 can include values of the length of a transmission window used by node device 200 for various number of node devices connected to the same access point as node device 200.

As described above, in some examples, node device 200 can operate in a first communication mode in which transceiver 206 communicates with one or more devices in a first type of network and can operate in a second communication mode in which transceiver 206 communicates with one or more devices in a second type of network. For example, while in the first communication mode, transceiver 206 transmits messages to and/or receives messages from devices in a first type of network (e.g., Cat-M1 network) via a first type of access point. As another example, while in the second communication mode, transceiver 206 transmits messages to and/or receives messages from devices in a second type of network (e.g., NB-IoT network) via a second type of access point. To account for differences between the constraints of the first and second access points, node device 200 can store a first set of one or more configuration tables 220 and/or a first set of one or more equations and/or algorithms 222 that are used for determining one or more operating parameters 218 of node device 200 when node device 200 is operating in the first communication mode. Furthermore, node device 200 can store a second set of one or more configuration tables 220 and/or a second set of one or more equations and/or algorithms 222 that are used for determining one or more operating parameters 218 of node device 200 when node device 200 is operating in the second communication mode. Stated another way, node device 200 can store a first set of one or more configuration tables 220 and/or a first set of one or more equations and/or algorithms 222 that are used for determining one or more operating parameters 218 of node device 200 when node device 200 is connected to an access point in a first type of network (e.g., Cat-M1 network) and can store a second set of one or more configuration tables 220 and/or a second set of one or more equations and/or algorithms 222 that are used for determining one or more operating parameters 218 of node device 200 when node device 200 is connected to an access point in a second type of network (e.g., NB-IoT network). In some examples, transceiver 206 can operate in more than two communication modes and/or communicate with devices in more than two different types of networks.

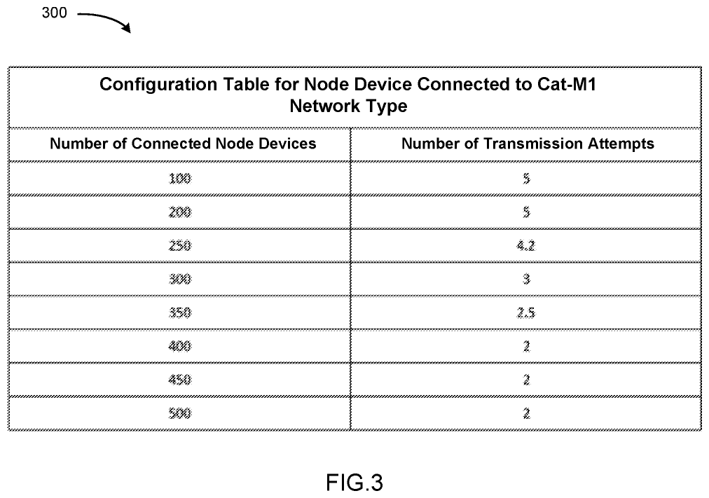

FIG. 3 illustrates an example configuration table 300 that is used to determine one or more operating parameters of a node device, according to various embodiments. For example, configuration table 300 can be used to determine one or more operating parameters 218 of node device 200. Configuration table 300 can be stored as a configuration table 220 in data store 214 of node device 200. In the illustrated example of FIG. 3, configuration table 300 is indicative of one or more operating parameters 218 of node device 200 when node device 200 is connected to a Cat-M1 network. That is, node device 200 uses configuration table 300 to determine one or more operating parameters 218 when node device 200 is connected to an access point (e.g., a sector antenna) to transmit messages to and/or receive messages from devices in a Cat-M1 network. Although configuration table 300 is illustrated and described with respect to operation of node device 200 in a Cat-M1 network, persons skilled in the art will understand that description of configuration table 300 is also applicable to configuration tables associated with operation of node devices connected to other types of networks.

As shown in FIG. 3, configuration table 300 includes a first column that indicates a number of node devices that are connected to an access point and a second column that indicates a number of transmission attempts that a node device should use when transmitting a message, such as a PON. Each respective number of transmission attempts that is included in the second column of configuration table 300 corresponds to a respective number of connected node devices included in the first column. For example, configuration table 300 indicates that when 100 node devices in a Cat-M1 network are connected to an access point that node device 200 is connected to (e.g., access point 106), node device 200 should use five transmission attempts to transmit a message to a device (e.g., control device 108) in the Cat-M1 network. That is, node device 200 should transmit a message, such as a PON, five times when 100 node devices in the Cat-M1 network are connected to the access point that node device 200 is connected to (e.g., access point 106).

As another example, configuration table 300 indicates that when 250 node devices in a Cat-M1 network are connected to the access point that node device 200 is connected to, node device 200 should use 4.2 transmission attempts to transmit a message to a device (e.g., control device 108) in the Cat-M1 network. That is, node device 200 should transmit a message, such as a PON, an average of 4.2 times when 250 node devices in the Cat-M1 network are connected to the access point to which node device 200 is connected (e.g., access point 106). As node device 200 cannot transmit a message 4.2 times, node device 200 can use a weighted random selection based on the whole number portion (e.g., 4) and the fractional number portion (e.g., 0.2) of the number of transmission attempts to determine a whole number of times to transmit the message. For example, node device 200 can use a weighted random selection in which four transmission attempts is weighted by a value of 0.8 and five transmission attempts is weighted by a value of 0.2, to determine a whole number of times (e.g., 4 or 5) to transmit a message when 250 node devices in the Cat-M1 network are connected to the access point to which node device 200 is connected.

As further shown in FIG. 3, configuration table 300 does not include a respective number of transmission attempts for every possible number of node devices connected to an access point to which node device 200 is connected. Rather, configuration table 300 only includes respective numbers of transmission attempts for a select number of node devices between 100 and 500 node devices connected to the access point to which node device 200 is connected (e.g., access point 106). As an example, configuration table 300 does not indicate an exact number of transmission attempts that node device 200 should use to transmit a message to a device in a Cat-M1 network when 375 node devices in the Cat-M1 network are connected to the access point to which node device 200 is connected. In this example, node device 200 can determine the number of transmission attempts to use when 375 node devices in the Cat-M1 network are connected to the access point by interpolating between the number of transmission attempts (e.g., 2.5) that corresponds to 350 connected node devices and the number of transmission attempts (e.g., 2) that corresponds to 400 connected node devices. Stated more generally, node device 200 can interpolate between transmission attempt values included in the second column of configuration table 300 when configuration table 300 does not indicate the number of transmission attempts to use for the exact number of node devices in the Cat-M1 network that are connected to the access point to which node device 200 is connected.

The value of each respective number of transmission attempts that is included in configuration table 300 is the number of transmission attempts that provides node device 200 with the highest chance of successfully transmitting a message to a device in a Cat-M1 network when the corresponding number of node devices indicated in the first column of configuration table 300 are connected to the access point to which node device 200 is connected. As a non-limiting example, when 100 node devices in a Cat-M1 network are connected to the access point to which node device 200 is connected, node device 200 can have the highest chance of successfully transmitting a message to a device in the Cat-M1 network when node device 200 transmits the message five times. As another non-limiting example, when 500 node devices in a Cat-M1 network are connected to the access point to which node device 200 is connected, node device 200 has the highest chance of successfully transmitting a message to a device in the Cat-M1 network when node device 200 transmits the message two times.

Persons skilled in the art will understand that the values of the number of connected node devices and/or the values for the number of transmission attempts shown in configuration table 300 are provided as non-limiting examples. Moreover, persons skilled in the art will understand that configuration table 300 can include respective values of transmission attempt numbers for more than 500 node devices (e.g., 1000, 10,000, 20,000, or more) connected to an access point. Although not shown, in some examples, the respective values of transmission attempt numbers included in configuration table 300 can be less than one (e.g., 0.5, 0.675, 0.3426, etc.)

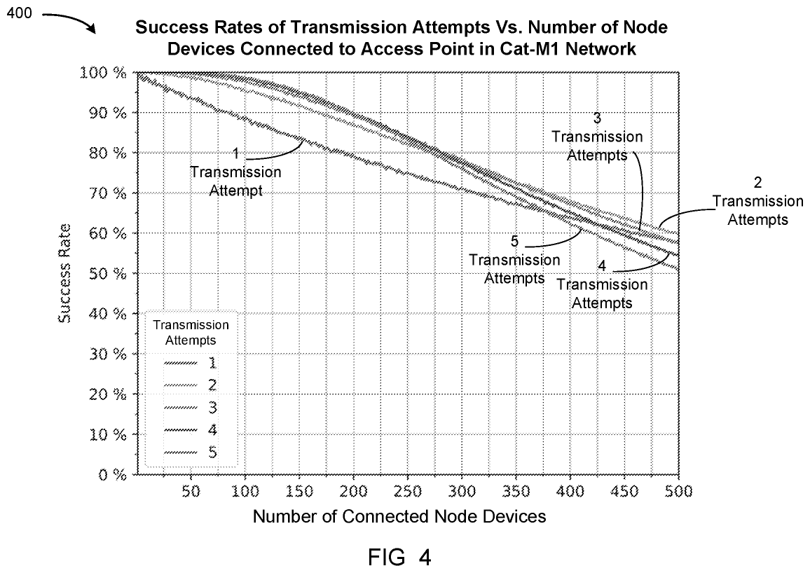

In some examples, the respective values of the transmission attempt numbers included in the second column of configuration table 300 can be determined experimentally and/or by simulating operation of a Cat-M1 network. FIG. 4 is a graph 400 illustrating the success rates of message transmissions in a constrained network, according to various embodiments. In particular, graph 400 illustrates the approximate success rates of messages that were transmitted, using different numbers of transmission attempts and within a specified time window (e.g., within a 90 second window), by various numbers of node devices connected to the same access point in a Cat-M1 network. For example, graph 400 illustrates the success rate of using one transmission attempt when various numbers of node devices connected to the same access point in a Cat-M1 network attempted to transmit a message within a 90 second window. Furthermore, graph 400 illustrates the success rate of using two transmission attempts, three transmission attempts, four transmission attempts, and five transmission attempts when various numbers of node devices connected to the same access point in a Cat-M1 network attempted to transmit a message within a 90 second window. In the illustrated example of FIG. 4, the 90 second time window during which the node devices attempt to transmit the messages corresponds to an amount of time that a node device has to transmit before the back-up power source of a node device is exhausted during a power outage.

As shown in FIG. 4, when 100 node devices in a Cat-M1 network are connected to the same access point (e.g., access point 106), a node device (e.g., node device 200) has the highest chance of successfully transmitting a message to a device (e.g., control device 108) in the Cat-M1 network when the node device transmits the message five times. For example, the success rate of transmitting a message five times when 100 nodes in the Cat-M1 network are connected to the same access point and attempting to transmit a message within a 90 second window is approximately 99%, which is higher than the respective success rates of using one, two, three, or four transmission attempts to transmit the message. Accordingly, configuration table 300 indicates that node device 200 should use five transmission attempts to transmit a message to a device in the Cat-M1 network when 100 node devices are connected to the same access point as node device 200. As further shown in FIG. 4, when 500 node devices in a Cat-M1 network are connected to the same access point (e.g., access point 106), a node device (e.g., node device 200) has the highest chance of successfully transmitting a message to a device (e.g., control device 108) in the Cat-M1 network when the node device transmits the message two times. For example, the success rate of transmitting a message two times when 500 nodes in the Cat-M1 network are connected to the same access point and attempting to transmit a message within a 90 second window is approximately 60%, which is higher than the respective success rates of using one, three, four, or five transmission attempts to transmit the message. Accordingly, configuration table 300 indicates that node device 200 should use two transmission attempts to transmit a message to a device in the Cat-M1 network when 500 node devices are connected to the same access point as the node device 200. Persons skilled in the art will understand that the success rates illustrated in FIG. 4 are just one non-limiting example of experimental and/or simulation results for transmitting a message in a Cat-M1 network. Moreover, persons skilled in the art will understand that in some examples, graph 400 can illustrate the success rates of respective transmission attempts for more than 500 connected node devices and/or the success rates of more than five transmission attempt values.

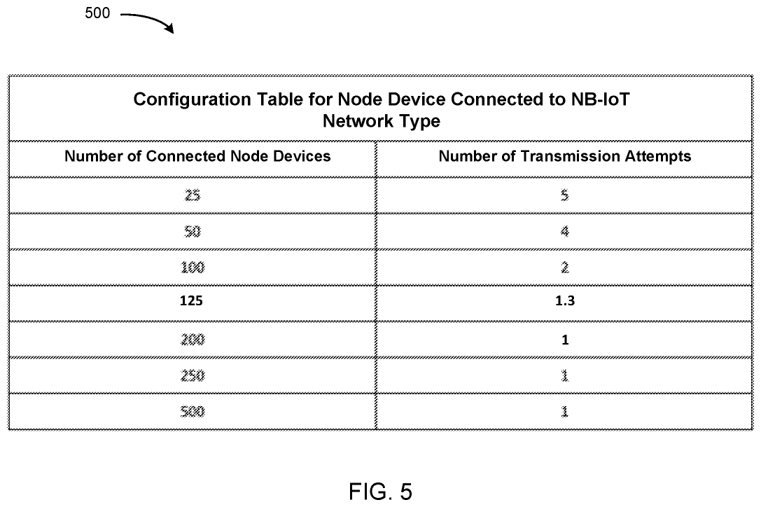

FIG. 5 illustrates an example configuration table 500 that is used to determine one or more operating parameters of a node device, according to various embodiments. For example, configuration table 300 can be used to determine one or more operating parameters 218 of node device 200. Configuration table 500 can be stored as a configuration table 220 in data store 214 of node device 200. In the illustrated example of FIG. 5, configuration table 500 is indicative of one or more operating parameters 218 of node device 200 when node device 200 is connected to an NB-IoT network. That is, node device 200 uses configuration table 500 to determine one or more operating parameters 218 when node device 200 is connected to an access point (e.g., a sector antenna) to transmit messages to and/or receive messages from devices in an NB-IoT network. Although configuration table 500 is illustrated and described with respect to operation of node device 200 in an NB-IoT network, persons skilled in the art will understand that description of configuration table 500 is also applicable to configuration tables associated with operation of node devices in other types of networks.

As shown in FIG. 5, configuration table 500 includes a first column that indicates a number of node devices that are connected to an access point and a second column that indicates a number of transmission attempts that a node device should use when transmitting a message, such a PON. Each respective number of transmission attempts that is included in the second column of configuration table 500 corresponds to a respective number of connected node devices included in the first column. For example, configuration table 500 indicates that when 100 node devices in an NB-IoT network are connected to the access point that node device 200 is connected to (e.g., access point 106), node device 200 should use two transmission attempts to transmit a message to other devices (e.g., control device 108) in the NB-IoT network. That is, node device 200 should transmit a message, such as a PON, two times when 100 node devices in the NB-IoT network are connected to the access point that node device 200 is connected to (e.g., access point 106). When compared to configuration table 300, which indicates that node device 200 should transmit a message, such as a PON, five times when 100 node devices in a Cat-M1 network are connected to the access point that node device 200 is connected to, configuration table 500 indicates that node device 200 should transmit a message fewer times (e.g., 2 times) when node device 200 is connected to an access point in an NB-IoT network that 100 node devices are connected to.

As another example, configuration table 500 indicates that when 125 node devices in an NB-IoT network are connected to the access point that node device 200 is connected to (e.g., access point 106), node device 200 should use 1.3 transmission attempts to transmit a message to other devices (e.g., control device 108) in the NB-IoT network. That is, node device 200 should transmit a message, such as a PON, an average of 1.3 times when 125 node devices in the NB-IoT network are connected to the access point to which node device 200 is connected (e.g., access point 106). As node device 200 cannot transmit a message 1.3 times, node device 200 can use a weighted random selection based on the whole number portion (e.g., 1) and the fractional number portion (e.g., 0.3) of the number of transmission attempts to determine a whole number of times to transmit the message. For example, node device 200 can use a weighted random selection in which one transmission attempt is weighted by a value of 0.7 and two transmission attempts is weighted by a value of 0.3 to determine a whole number of times (e.g., 1 or 2) to transmit a message when 125 node devices in the NB-IoT network are connected to the access point to which node device 200 is connected.

As further shown in FIG. 5, configuration table 500 does not include a respective number of transmission attempts for every possible number of node devices connected to an access point to which node device 200 is connected. Rather, configuration table 500 only includes respective numbers of transmission attempts for a select number of node devices between 25 and 500 node devices connected to the access point to which node device 200 is connected (e.g., access point 106). As an example, configuration table 500 does not indicate an exact number of transmission attempts that node device 200 should use to transmit a message to a device in an NB-IoT network when 70 node devices in the NB-IoT network are connected to the access point to which node device 200 is connected. In this example, node device 200 can determine the number of transmission attempts to use when 70 node devices in the NB-IoT network are connected to the access point by interpolating between the number of transmission attempts (e.g., 4) that corresponds to 50 connected node devices and the number of transmission attempts (e.g., 2) that corresponds to 100 connected node devices. Stated more generally, node device 200 can interpolate between transmission attempt values included in the second column of configuration table 300 when configuration table 500 does not indicate the number of transmission attempts to use for the exact number of node devices in the NB-IoT network that are connected to the access point to which node device 200 is connected.

The value of each respective number of transmission attempts that is included in configuration table 500 is the number of transmission attempts that provides node device 200 with the highest chance of successfully transmitting a message to a device in an NB-IoT network when the corresponding number of node devices indicated in the first column of configuration table 500 are connected to the access point to which node device 200 is connected. In one non-limiting example, when 100 node devices in an NB-IoT network are connected to the access point to which node device 200 is connected, node device 200 can have the highest chance of successfully transmitting a message to a device in the NB-IoT network when node device 200 transmits the message two times. As another non-limiting example, when 500 node devices in an NB-IoT network are connected to the access point to which node device 200 is connected, node device 200 can have the highest chance of successfully transmitting a message to a device in the NB-IoT network when node device 200 transmits the message one time.

Persons skilled in the art will understand that the values of the number of connected node devices and/or the values for the number of transmission attempts shown in configuration table 500 are provided as non-limiting examples. Moreover, persons skilled in the art will understand that configuration table 500 can include respective values of transmission attempt numbers for more than 500 node devices (e.g., 1000, 10,000, 20,000, or more) connected to an access point. Although not shown, in some examples, the respective values of transmission attempt numbers included in configuration table 500 can be less than one (e.g., 0.5, 0.675, 0.3426, etc.)

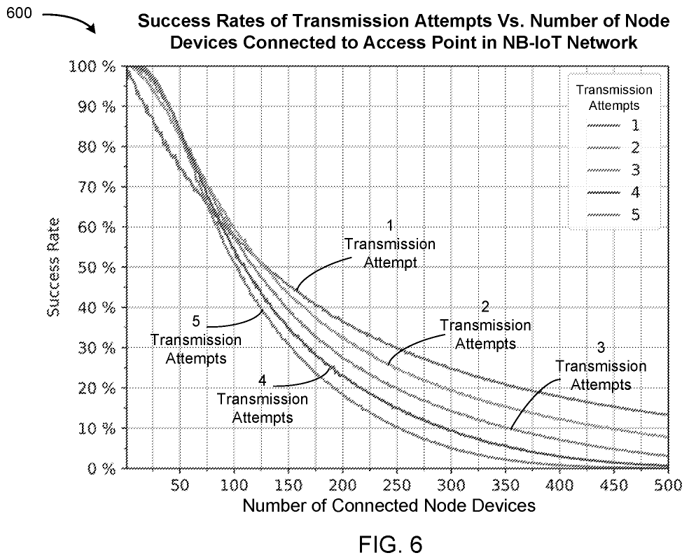

In some examples, the respective values of the transmission attempt numbers included in configuration table 500 can be determined experimentally and/or by simulating operation of an NB-IoT network. FIG. 6 is a graph 600 illustrating the success rates of message transmissions in a constrained network, according to various embodiments. In particular, graph 600 illustrates the approximate success rates of messages that were transmitted, using different numbers of transmission attempts and within a specified time window (e.g., within a 90 second window), by various numbers of node devices connected to the same access point in an NB-IoT network. For example, graph 600 illustrates the success rate of using one transmission attempt when various numbers of node devices connected to the same access point in an NB-IoT network attempted to transmit a message within a 90 second window. Furthermore, graph 600 illustrates the success rate of using two transmission attempts, three transmission attempts, four transmission attempts, and five transmission attempts when various numbers of node devices connected to the same access point in an NB-IoT network attempted to transmit a message within a 90 second window. In the illustrated example of FIG. 6, the 90 second time window during which the node devices attempt to transmit the messages corresponds to an amount of time that a node device has to transmit before the back-up power source of a node device is exhausted during a power outage.

As shown in FIG. 6, when 100 node devices in an NB-IoT network are connected to the same access point (e.g., access point 106), a node device (e.g., node device 200) has the highest chance of successfully transmitting a message to a device (e.g., control device 108) in the NB-IoT network when the node device transmits the message two times. For example, the success rate of transmitting a message two times when 100 nodes in the NB-IoT network are connected to the same access point and attempting to transmit a message within a 90 second window is approximately 60%, which is higher than the respective success rates of using one, three, four, or five transmission attempts to transmit the message. Accordingly, configuration table 500 indicates that node device 200 should use two transmission attempts to transmit a message to a device in the NB-IoT network when 100 node devices are connected to the same access point as node device 200. As further shown in FIG. 6, when 500 node devices in an NB-IoT network are connected to the same access point (e.g., access point 106), a node device (e.g., node device 200) can have the highest chance of successfully transmitting a message to a device (e.g., control device 108) in the NB-IoT network when the node device transmits the message one time. For example, the success rate of transmitting a message one time when 500 nodes in the NB-IoT network are connected to the same access point and attempting to transmit a message within a 90 second window is approximately 13%, which is higher than the respective success rates of using one, two, three, or four transmission attempts to transmit the message. Accordingly, configuration table 500 indicates that node device 200 should use one transmission attempt to transmit a message to a device in the NB-IoT network when 500 node devices are connected to the same access point as node device 200. Persons skilled in the art will understand that the success rates illustrated in FIG. 6 are just one non-limiting example of experimental and/or simulation results for transmitting a message in a Cat-M1 network. Moreover, persons skilled in the art will understand that in some examples, graph 600 can illustrate the success rates of respective transmission attempts for more than 500 connected node devices and/or the success rates of more than five transmission attempt values.

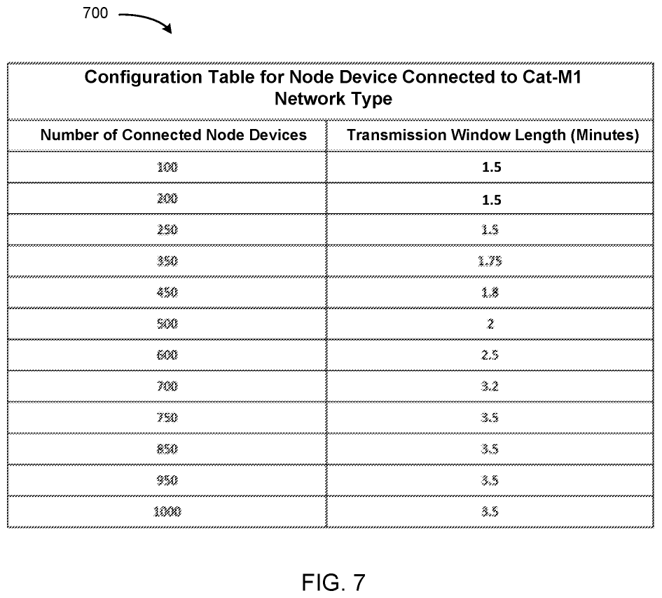

FIG. 7 illustrates an example configuration table 700 that is used to determine one or more operating parameters of a node device, according to various embodiments. For example, configuration table 700 can be used to determine one or more operating parameters 218 of node device 200. Configuration table 700 can be stored as a configuration table 220 in data store 214 of node device 200. In the illustrated example of FIG. 7, configuration table 700 is indicative of one or more operating parameters 218 of node device 200 when node device 200 is connected to a Cat-M1 network. That is, node device 200 uses configuration table 700 to determine one or more operating parameters 218 when node device 200 is connected to an access point (e.g., sector antenna) to transmit messages to and/or receive messages from devices in a Cat-M1 network. Although configuration table 700 is illustrated and described with respect to operation of node device 200 in a Cat-M1 network, persons skilled in the art will understand that description of configuration table 700 is also applicable to configuration tables associated with operation of node devices in other types of networks.

As shown in FIG. 7, configuration table 700 includes a first column that indicates a number of node devices that are connected to an access point and a second column that indicates a length, in minutes, of a transmission window during which a node device should randomly transmit a message, such as a PRN, to a device in the Cat-M1 network. Each respective transmission window length that is included in the second column of configuration table 700 corresponds to a respective number of connected node devices included in the first column. For example, configuration table 700 indicates that when 100 node devices in a Cat-M1 network are connected to the access point that node device 200 is connected to (e.g., access point 106), node device 200 should randomly transmit a message, such as a PRN, to a device (e.g., access point 106 or control device 108) in the Cat-M1 network during a transmission window that is 1.5 minutes long. That is, node device 200 should transmit a message, such as a PRN, at a random time during a 1.5 minute long transmission window when 100 node devices in the Cat-M1 network are connected to the access point that node device 200 is connected to (e.g., access point 106). As another example, configuration table 700 indicates that when 1000 node devices in a Cat-M1 network are connected to the access point that node device 200 is connected to (e.g., access point 106), node device 200 should randomly transmit a message, such as a PRN, to a device (e.g., control device 108) in the Cat-M1 network during a transmission window that is 3.5 minutes long. That is, node device 200 should transmit a message, such as a PRN, at a random time during a 3.5 minute long transmission window when 1000 node devices in the Cat-M1 network are connected to the access point that node device 200 is connected to (e.g., access point 106).

In the illustrated example of FIG. 7, configuration table 700 does not include a respective transmission window length for every possible number of node devices connected to an access point to which node device 200 is connected. Rather, configuration table 700 includes respective transmission window lengths for a select number of node devices between 100 and 1000 node devices connected to the access point to which node device 200 is connected (e.g., access point 106). However, persons skilled in the art will understand that configuration table 700 can include respective transmission window lengths for fewer than 100 node devices, more than 1000 node devices (e.g., 10,000 node devices, 20,000 node devices, or more), or some other value of node devices connected to the access point to which node device 200 is connect.

As a non-limiting example, configuration table 700 does not indicate an exact transmission window length that node device 200 should use to transmit a message to a device in a Cat-M1 network when 550 node devices in the Cat-M1 network are connected to the access point to which node device 200 is connected. In this non- limiting example, node device 200 can determine the transmission window length to use when 550 node devices in the Cat-M1 network are connected to the access point by interpolating between the transmission window length (e.g., 2 minutes) that corresponds to 500 connected node devices and the transmission window length (e.g., 2.5 minutes) that corresponds to 600 connected node devices. Stated more generally, node device 200 can interpolate between transmission window lengths included in the second column of configuration table 700 when configuration table 700 does not indicate the transmission window length to use for the exact number of node devices in the Cat-M1 network that are connected to the access point to which node device 200 is connected.

The value of each respective transmission window length that is included in configuration table 700 is the transmission window length that, when used by node devices connected to the same access point in a Cat-M1 network to transmit a message such as a PRN, results in the shortest amount of time taken for all the node devices connected to the same access point (e.g., access point 106) to reconnect, or register, with a control device (e.g., control device 108) in the Cat-M1 network after power is restored to the node devices. As a non-limiting example, when 100 node devices in a Cat-M1 network are connected to the same access point when power is restored to the 100 node devices after a power outage, the 100 node devices can reconnect, or register, with a control device in the shortest amount of time when the 100 node devices randomly transmit PRNs within transmission windows that are 1.5 minutes long. As another non-limiting example, when 1000 node devices in a Cat-M1 network are connected to the same access point when power is restored to the 1000 node devices after a power outage, the 1000 node devices can reconnect, or register, with a control device in the shortest amount of time when the 1000 node devices randomly transmit PRNs within transmission windows that are 3.5 minutes long.

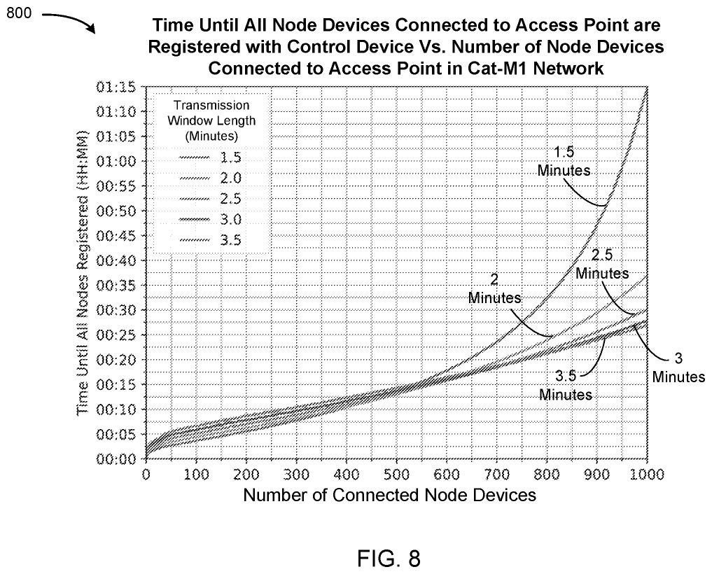

The respective values of the transmission window lengths included in configuration table 700 can be determined experimentally and/or by simulating operation of a Cat-M1 network. FIG. 8 is a graph 800 illustrating amounts of time taken for node devices to register with a control device in a constrained network according to various embodiments. In particular, graph 800 illustrates the approximate amounts of time for various numbers of nodes connected to the same access point in a Cat-M1 network to reconnect, or register, with a control device in the Cat-M1 network transmitting messages, such as PRNs, at random times within transmission windows of various lengths. For example, graph 800 illustrates the amount of time taken for various numbers of node devices connected to the same access point in a Cat-M1 network when the various numbers of node devices transmit messages, such as PRNs, at random times within transmission windows that are 1.5 minutes long. Furthermore, graph 800 illustrates the amount of time taken for various numbers of node devices connected to the same access point in a Cat-M1 network when the various numbers of node devices transmit messages, such as PRNs, at random times within transmission windows that are two minutes long, transmission windows that are 2.5 minutes long, transmission windows that are three minutes long, and transmission windows that are 3.5 minutes long.

As shown in FIG. 8, when 100 node devices in a Cat-M1 network are connected to the same access point (e.g., access point 106), the 100 node devices can reconnect, or register, with a control device (e.g., control device 108) in the Cat-M1 network in the shortest amount of time when the 100 node devices transmit messages, such as PRNs, to the control device at random times within transmission windows that are 1.5 minutes long. For example, the amount of time it takes for 100 node devices in a Cat-M1 network that are connected to the same access point to reconnect, or register, with a control device in the Cat-M1 network is approximately 6 minutes and 38 seconds when the 100 devices transmit messages, such as PRNs, to the control device at random times within transmission windows that are 1.5 minutes long. As shown in FIG. 6, 6 minutes and 38 seconds is shorter than the amounts of time taken for 100 node devices in a Cat-M1 network that are connected to the same access point to reconnect, or register, with a control device Cat-M1 network when the 100 node devices use transmission windows that are longer that 1.5 minutes. Persons skilled in the art will understand that the amounts of time for node devices to reconnect with a control device illustrated in FIG. 8 are just one non-limiting example of experimental and/or simulation results for operation of a Cat-M1 network.

Although configuration table 300, configuration table 500, and configuration table 700 are illustrated and described as separate configuration tables, in some embodiments, one or more of configuration tables 300, 500, and 700 can be combined into a single table that is stored as a configuration table 220 in data store 214 of node device 200. Furthermore, persons skilled in the art will understand that configuration tables 300, 500, and 700 are provided as non-limiting examples of possible configuration tables 220 that can be stored in data store 214 of node device 200. Moreover, other configuration tables not illustrated and described herein can be stored as configuration tables 220 in data store 214 of node device 200.

Referring back to FIG. 2, when executed by processor 202, messaging application 216 handles the transmission of messages to other devices in the network (e.g., control device 108) by node device 200 and the reception of messages transmitted to node device 200 by other devices in the network (e.g., control device 108). In operation, messaging application 216 interfaces with transceiver 206 to establish a connection with an access point (e.g., access point 106) in a network. For example, establishing a connection with an access point (e.g., access point 106) can include establishing a wireless communication link between first node messaging application 216 and the access point. As described herein, the access point with which messaging application 216 establishes a connection is a device that enables node device 200 to transmit messages to and/or receive messages from other devices, such as control device 108, in a network. In some embodiments, the access point is a sector antenna located at a cellular base station. In other embodiments, the access point is one or more of a wireless access point, a router, a gateway, a transceiver, or some other type of network device that enables nodes to connect to and/or communicate with devices in the network. In other embodiments, the access point is another node device, such as first node 102, second node 104, or a node device 200.

When messaging application 216 is connected to an access point (e.g., access point 106), messaging application 216 interfaces with transceiver 206 to receive messages transmitted by other devices in the network to node device 200. For example, messaging application 216 receives messages that are transmitted by a control device, such as control device 108, to node device 200. In some instances, messaging application 216 receives one or more messages transmitted by a control device that include information that indicates how many node devices are connected to the access point to which node device 200 is connected. In such instances, messaging application can determine and configure one or more operating parameters 218 of node device 200 based on the number of node devices that are connected to the access point to which node device 200 is connected.

Messaging application 216 can use one or more configuration tables 220 and/or one or more equations and/or algorithms 222 to determine, based on the number of node devices that are connected to the access point to which node device 200 is connected, one or more operating parameters 218 of node device 200. For example, messaging application 216 uses one or more configuration tables 220 and/or one or more equations and/or algorithms 222 to determine how many times to transmit a message, such as a PON, to a device in the network based on the number of node devices that are connected to the access point to which node device 200 is connected. After determining how many times to transmit a message to a device in the network, messaging application 216 configures, or sets a value of, the number of transmission attempts included in one or more operating parameters 218. As another example, messaging application 216 uses one or more configuration tables 220 to determine the length of a transmission window during which messaging application 216 randomly transmits a message, such as a PRN, to a device in the network based on the number of node devices that are connected to the access point to which node device 200 is connected. After determining the length of the transmission window during which messaging application 216 randomly transmits a message, messaging application 216 configures, or sets a value of, the transmission window length included in one or more operating parameters 218.

In one example, when messaging application 216 is connected to an access point in a first type of network, such as a Cat-M1 network, messaging application 216 uses configuration table 300 and/or one or more equations and/or algorithms 222 to determine a number of times to transmit a message, such as a PON, to a control device in the network. In another example, when messaging application 216 is connected to an access point in a second type of network, such as an NB-IoT network, messaging application 216 uses configuration table 500 and/or one or more equations and/or algorithms 222 to determine a number of times to transmit a message, such as a PON, to a control device in the network. In another example, when messaging application 216 is connected to an access point in a first type of network, such as a Cat-M1 network, messaging application 216 uses configuration table 700 and/or one or more equations and/or algorithms 222 to determine a length of a transmission window during which messaging application 216 randomly transmits a message, such as a PRN, to a control device in the network. In another example, when messaging application 216 is connected to an access point in a second type of network, such as an NB-IoT network, messaging application 216 uses a different configuration table included in the one or more configuration tables 220 and/or one or more equations and/or algorithms 222 to determine a length of a transmission window during which messaging application 216 randomly transmits a message, such as a PRN, to a control device in the network.

In some examples, messaging application 216 does not determine values of the one or more operating parameters 218. In such examples, messaging application 216 can receive one or more messages from a control device (e.g., control device 108) that includes information that includes and/or is indicative of values of operating parameters to be used by node device 200. Furthermore, in such examples, messaging application 216 configures, or sets the values of, the one or more operating parameters 218 based on the values of the operating parameters included in the messages received from the control device.

In operation, messaging application 216 further interfaces with transceiver 206 to transmit, via an access point (e.g., access point 106), one or more messages to devices in the network in accordance with one or more operating parameters 218. For example, messaging application 216 transmits, via access point 106, a message such as a PON to control device 108 the number of times that has been configured in operating parameter(s) 218. As another example, messaging application 216 transmits, via access point 106, a message such as a PRN to control device 108 at a random time during a transmission window of a length that has been configured in operating parameter(s) 218. As another example, messaging application 216 transmits, via access point 106, one or more messages that include billing information and/or metrology data in accordance with one or more operating parameters 218. In some examples, messaging application 216 transmits one or more messages in accordance with operating parameter(s) 218 on a periodic and/or ad-hoc basis. For example, messaging application 216 transmits, via access point 106, one or more messages indicative of a status of node device 200 to control device 108 once per day, once per week, or at some other interval. In some examples, messaging application 216 transmits one or more messages in accordance with operating parameter(s) 218 in response to a trigger event. A trigger event can be, for example, a power outage, a restoration of power after the occurrence of a power outage, a scheduled time to transmit billing information, a scheduled time to transmit metrology data, or some other event that causes messaging application 216 to transmit one or more messages.

In one example, messaging application 216 transmits, via an access point (e.g., access point 106), one or more messages in accordance with operating parameter(s) 218 to a device (e.g., control device 108) in response to determining that a power outage has occurred and/or that power supply 208 of node device 200 is disconnected from mains-power and/or depleted. For example, messaging application 216 transmits one or more PONs to notify a device (e.g., control device 108) of the power outage. As a non-limiting example, it will be assumed that 500 node devices in a Cat-M1 network are connected to the access point to which node device 200 is connected (e.g., access point 106). Accordingly, in this non-limiting example, messaging application 216 uses configuration table 300 and/or one or more equations and/or algorithms 222 to determine to transmit a PON to control device 108 two times.

In another non-limiting example, in response to determining that power has been restored after a power outage, messaging application 216 transmits, via an access point (e.g., access point 106), one or more PRNs to control device 108 in accordance with operating parameter(s) 218. Messaging application 216 can determine that power has been restored when power supply 208 is reconnected to mains-power and/or a battery in power supply 208 is recharged after a power outage. As an example, it will be assumed that 500 node devices in a Cat-M1 network are connected to the access point to which node device 200 is connected (e.g., access point 106). Accordingly, in this example, messaging application 216 uses configuration table 700 and/or one or more equations and/or algorithms 222 to determine to transmit a PRN to control device 108 at a random time during a transmission window that is two minutes long. As described herein, messaging application 216 transmits a PRN to reconnect, or register, with control device 108. If messaging application 216 does not receive an acknowledgement message from control device 108 that indicates messaging application 216 has reconnected, or registered, with control device 108, messaging application 216 transmits another PRN to control device 108 at a random time during a transmission window that is two minutes long. In this example, messaging application 216 continues to transmit PRNs to control device 108 at random times in two minute long transmission windows until the messaging application 216 receives an acknowledgement message from control device 108.

In some examples, messaging application 216 transmits a registration message, such as a PRN, in accordance with one or more operating parameters 218 to reconnect, or register, with access point 106 when power is restored after the occurrence of a power outage. If messaging application 216 does not receive an acknowledgement message from access point 106 that indicates messaging application 216 has reconnected, or registered, with access point 106, messaging application 216 transmits another registration message to access point 106 in accordance with one or more operating parameters 218. For example, messaging application 218 transmits another registration message to access point 106 at a random time within a transmission window of a length specified by one or more operating parameters 218. In this example, messaging application 216 continues to transmit registration messages to access point 106 at random times in transmission windows of lengths specified by one or more operating parameters 218 until messaging application 216 receives an acknowledgement message from access point 106.

### Control Device

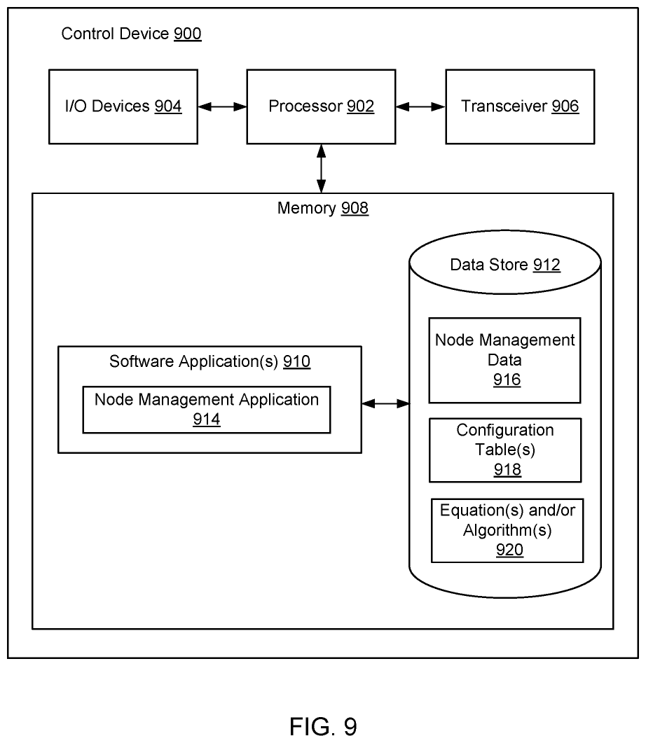

FIG. 9 illustrates control device 900, according to various embodiments. In some embodiments, control device 900 is used to implement control device 108 of FIG. 1. In some embodiments control device 900 is a computing device, such as a headend device, a backend server, or some other computing device, located at an office or other facility of a utility provider. As shown, control device 900 includes, without limitation, processor 902, I/O devices 904, transceiver 906, and memory 908, coupled together.

Processor 902 coordinates operations of control device 900. In various embodiments, processor 902 includes any hardware configured to process data and execute software applications. Processor 902 can be any technically feasible processing device configured to process data and execute program instructions. For example, processor 902 could include one or more CPUs, DSPs, GPUs, ASICS, FPGAs, microprocessors, microcontrollers, other types of processing units, and/or a combination of different processing units. Processor 902 can include an RTC (not shown) according to which processor 902 maintains an estimate of the current time. The estimate of the current time can be expressed in UTC, although any other standard of time measurement can also be used.

I/O devices 904 include devices configured to receive input, devices configured to provide output, and devices configured to both receive input and provide output. Transceiver 906 is configured to transmit messages to and/or receive messages from other devices, such as first node 102, second node 104, node device 200, and/or other devices connected to the network.

Memory 908 includes one or more software applications 910 and a data store 912, coupled together. As shown, the one or more software applications 910 include node management application 914. Data store 912 stores node management data 916. Node management data 916 includes one or more tables that indicate how many node devices, such as first node(s) 102, second node(s) 104, node devices 200, and/or other communication devices, are connected to respective access points in one or more networks. For example, node management data 916 includes a first table that indicates how many node devices 200 are connected to a first access point, such as access point 106, and one or more other tables that indicate how many node devices are respectively connected to other access points. In some examples, the one or more tables included in node management data 916 include identifying information, such as unique identifiers, associated with the respective node devices 200 connected to access points. For example, in addition to storing a number of node devices 200 connected to a particular access point, a table included in node management data 216 can also include identifying information associated with each node device 200 that is connected to the particular access point.

In some examples, data store 912 further includes one or more configuration tables 918 and/or one or more equations and/or algorithms 920 that can be used to determine, based on a number node devices connected to an access point (e.g., access point 106), one or more operating parameters for node devices such as first node(s) 102, second node(s) 104, node devices 200, and/or other communication devices connected to the access point. The one or more configuration tables 918 can be the same as or similar to the one or more configuration tables 220 stored in data store 214 of node device 200. Similarly, the one or more equations and/or algorithms 920 can be the same as or similar to the one or more equations and/or algorithms stored in data store 214 of node device 200.

When executed by processor 902, node management application 914 updates node management data 916 in accordance with messages received from node devices. For example, node management application 914 interfaces with transceiver 906 to receive messages from one or more node devices, such as node device 200, that indicate which access points the one or more node devices are connected to. As an example, when node management application 914 receives a message from node device 200 that indicates node device 200 is connected to access point 106, node management application 914 checks node management data 916 to determine whether node management data 916 indicates that node device 200 is connected to access point 106. If node management data 916 already indicates that node device 200 is connected to access point 106, then node management application 914 does not update node management data 916. However, if node management data 916 does not indicate that node device 200 is connected to access point 106, node management application 914 can add node device 200 to a table in node management data 916 that includes a list of node devices 200 connected to access point 106. In some examples, the list of node devices connected to access point 106 can include identifying information associated with each of the node device 200 connected to access point 106. Node management application 914 further updates the count, or number, of nodes connected to access point 106 while adding node device 200 to the list of node devices connected to access point 106.

In some examples, node management application 914 also updates node management data 916 when node management application 914 does not receive a message from a particular node device, such as node device 200, for an extended period of time (e.g., 1 month, 3 months, 6 months, etc.). As an example, it will be assumed that a table in node management data 916 that includes a list of node devices connected to access point 106 indicates that node device 200 is connected to access point 106. However, if node management application 914 does not receive any message from node device 200, such as a message that indicates node device 200 is connected to access point 106, for an extended period of time, then node management application 914 removes node device 200 from the list of node devices 200 connected to access point 106. Node management application 914 further updates the count, or number, of nodes connected to access point 106 after removing node device 200 from the list of node devices 200 connected to access point 106.

In some examples, a first node device 200 establishes a connection with a new access point, or switches access points, while connected to a first access point. In such examples, node management application 914 receives a message from the first node device 200 that indicates the first node device 200 is connected to the new access point. In response, node management application 914 updates node management data 916 to remove the first node device 200 from a list of node devices 200 connected to the first access point and adds the first node device 200 to a list of node devices 200 connected to the new access point. In addition, node management application 914 updates the respective counts, or numbers, of node devices connected to the first access point and the new access point.

When node management application 914 is executed by processor 902, node management application 914 also transmits one or more messages to node devices 200. The information included in the one or more messages transmitted by the node device 200 can include and/or indicate a number of node devices 200 that are connected to an access point. In some examples, node management application 914 interfaces with transceiver 906 to transmit one or more messages that indicate how many node devices 200 are connected to an access point in response to node management application 914 receiving a message from a node device 200 that indicates it is connected to the access point. As an example, node management application 914 receives a message from node device 200 that indicates that node device 200 is connected to access point 106. In response to receiving this message, node management application 914 updates node management data 916 based on the received message as described above and transmits one or more messages to node device 200 and/or other node devices 200 connected to access point 106 that indicate how many node devices 200 are connected to access point 106. In some examples, node management application 914 interfaces with transceiver 906 to transmit one or more messages that indicate how many node devices 200 are connected to an access point on a periodic or ad-hoc basis. For example, node management application 914 transmits one or more messages to node devices 200 connected to access point 106 that indicate how many node devices are connected to access point 106 periodically (e.g., weekly, monthly, etc.) and/or on an ad-hoc basis.

In some examples, when node management application 914 is executed by processor 902, node management application 914 determines the values of one or more operating parameters for node devices 200 connected to an access point (e.g., access point 106). For example, similar to how messaging application 216 of a node device 200 can determine, based on a number of node devices connected to an access point, values of one or more operating parameters 218 by using one or more configuration tables 220 and/or equations and/or algorithms 222, node management application 914 can use one or more configuration tables 918 and/or equations and/or algorithms 920 to determine, based on a number node devices 200 connected to an access point, the values of one or more operating parameters 218 for the node devices 200 connected to the access point. In such examples, node management application 914 transmits one or more messages to one or more of the node devices 200 connected to the same access point. These one or more messages include information that includes and/or indicates the values of one or more operating parameters 218 for the node devices 200 connected to the same access point. In some examples, the information included in these one or more messages further includes and/or indicative that number of node device 200 connected to the same access point.

### Optimizing Traffic in a Constrained Network

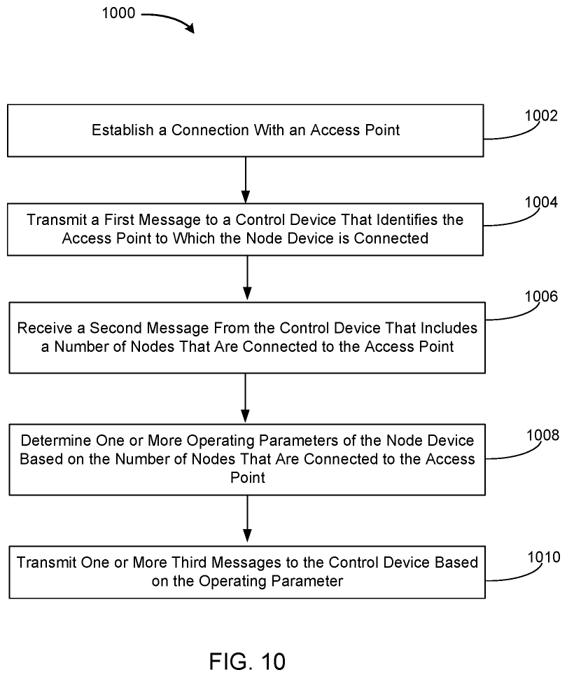

FIG. 10 is a flow diagram of method steps for optimizing traffic in a constrained network, according to various embodiments. Although the method steps of FIG. 10 are described as being performed by node device 200 using messaging application 216, the method steps of FIG. 10 can also be performed, for example, by first node 102, second node 104, control device 108, control device 900, or some other communication device connected to a network as described above with respect to FIGS. 1-9. Furthermore, although the method steps are shown in an order, persons skilled in the art will understand that some method steps may be performed in a different order, repeated, and/or performed by components other than those described in FIG. 10.

As shown, a method 1000 begins at step 1002, where messaging application 216 establishes a connection with an access point. For example, messaging application 216 establishes a connection with access point 106. Establishing a connection with access point 106 can include establishing a wireless communication link between first node device 200 and access point 106. As described herein, access point 106 can be implemented as one or more of a sector antenna located at a cellular base station, a wireless access point, a router, a gateway, a transceiver, or some other type of network device that enables nodes to connect to and/or communicate with devices in a network. In some examples, access point 106 is another node device 200.

At step 1004, messaging application 216 transmits a first message to a control device that identifies the access point to which node device 200 is connected. For example, messaging application 216 interfaces with transceiver 206 to transmit a first message, via access point 106, to control device 900. This first message identifies that node device 200 is connected to access point 106 and/or includes a unique identifier associated with access point 106.

At step 1006, messaging application 216 receives, from the control device, a second message that includes a number of nodes that are connected to the access point to which the node device 200 is connected. For example, messaging application 216 interfaces with transceiver 206 to receive a message transmitted by control device 900 that indicates how many node devices are connected to access point 106.

At step 1008, messaging application 216 determines and/or adjusts one or more operating parameters 218 of node device 200 based on the number of nodes that are connected to the access point to which node device 200 is connected. As described herein, messaging application 216 uses one or more configuration tables 220 and/or equations and/or algorithms 222 to determine one or more operating parameters 218 of node device 200 based on the number of nodes that are connected the access point to which node device 200 is connected. As an example, when messaging application 216 is connected to access point 106, messaging application 216 uses one or more configuration tables 220 and/or equations and/or algorithms 222 to determine a number of times that messaging application 216 transmits a message based on the number of nodes that are connected to access point 106. As another example, when messaging application 216 is connected to access point 106, messaging application 216 uses one or more configuration tables 220 and/or equations and/or algorithms 222 to determine a length of a transmission window during which messaging application 216 transmits a message at a random time.

At step 1010, messaging application 216 transmits one or more third messages to the control device based on the one or more operating parameters that were determined at step 1008. In one example, messaging application 216 transmits, via access point 106, one or more third messages to control device 900 a number of times that was determined at step 1008. In this example, the one or more third messages can include one or more PONs that are transmitted by messaging application 216 in response to determining that a power outage has occurred. In another example, messaging application 216 transmits, via access point 106, one or more third messages to control device 900 at random times within transmission windows of a length that was determined at step 1008. In this example, the one or more third messages can include one or more PRNs that messaging application 216 transmits in response to determining that power has been restored after a power outage has occurred. In some examples, messaging application 216 transmits, via access point 106, one or more third messages to control device 900 on a periodic and/or ad-hoc basis based on the one or more operating parameters determined at step 1008. In some examples, the one or more third messages include metrology data and/or billing information.

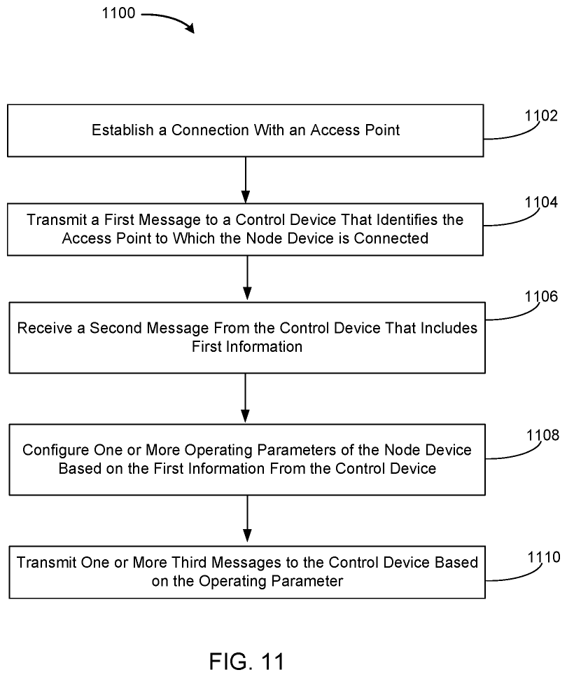

FIG. 11 is a flow diagram of method steps for optimizing traffic in a constrained network, according to various embodiments. Although the method steps of FIG. 11 are described as being performed by node device 200 using messaging application 216, the method steps of FIG. 11 can also be performed, for example, by first node 102, second node 104, control device 108, control device 900, or some other communication device connected to a network as described above with respect to FIGS. 1-9. Furthermore, although the method steps are shown in an order, persons skilled in the art will understand that some method steps may be performed in a different order, repeated, and/or performed by components other than those described in FIG. 11.

As shown, a method 1100 begins at step 1102, where messaging application 216 establishes a connection with an access point. For example, messaging application 216 establishes a connection with access point 106. Establishing a connection with access point 106 can include establishing a wireless communication link between first node device 200 and access point 106. As described herein, access point 106 can be implemented as one or more of a sector antenna located at a cellular base station, a wireless access point, a router, a gateway, a transceiver, or some other type of network device that enables nodes to connect to and/or communicate with devices in a network. In some examples, access point 106 is another node device 200.

At step 1104, messaging application 216 transmits a first message to a control device that identifies the access point to which node device 200 is connected. For example, messaging application 216 interfaces with transceiver 206 to transmit a first message, via access point 106, to control device 900. This first message identifies that node device 200 is connected to access point 106 and/or includes a unique identifier associated with access point 106.

At step 1106, messaging application 216 receives, from the control device, a second message that includes first information. As described herein, in some examples, the first information includes and/or indicates a number of node devices 200 that are connected to access point 106. In other examples, the first information includes values for one or more operating parameters of the node device 200. For example, messaging application 216 interfaces with transceiver 206 to receive a message transmitted by control device 900 that indicates values for one or more operating parameters 218 of node device 200. As described herein, node management application 914 executing on processor 902 of a control device 900 can use one or more configuration tables 918 and/or equations and/or algorithms 920 to determine, based on a number of nodes that are connected to the access point to which a node device 200 is connected, values of one or more operating parameters 218 of the node device 200. The values for the one or more operating parameters included in the second message can include, for example, a number of times that messaging application 216 transmits a message and/or a length of a transmission window during which messaging application 216 randomly transmits a message. In some examples, the second message also includes the number of nodes that are connected to the access point to which the node device 200 is connected.

At step 1108, messaging application 216 configures and/or sets the values of one or more operating parameters 218 of node device 200 based on the first information that is included in the second message. For example, messaging application 216 configures and/or sets the values of one or more operating parameters 218 of node device 200 based on the values for the one or more operating parameters that are included in the first information included in the second message received at step 1106. As another example, messaging application 216 configures and/or sets the values of one or more operating parameters 218 of node device 200 based on a number of node devices 200 connected to the access point to which node device 200 is connected included in the first information included in the second message received at step 1106.

At step 1110, messaging application 216 transmits one or more third messages to the control device based on the one or more operating parameters that were configured at step 1108. In one example, messaging application 216 transmits, via access point 106, one or more third messages to control device 900 a number of times that was configured at step 1108. In this example, the one or more third messages can include one or more PONs that are transmitted by messaging application 216 in response to determining that a power outage has occurred. In another example, messaging application 216 transmits, via access point 106, one or more third messages to control device 900 at random times within transmission windows of a length that was configured at step 1108. In this example, the one or more third messages can include one or more PRNs that messaging application 216 transmits in response to determining that power has been restored after a power outage has occurred. In some examples, messaging application 216 transmits, via access point 106, one or more third messages to control device 900 on a periodic and/or ad-hoc basis based on the one or more operating parameters determined at step 1108. In some examples, the one or more third messages include metrology data and/or billing information.

### Registering with an Access Point and/or a Control Device in a Constrained Network

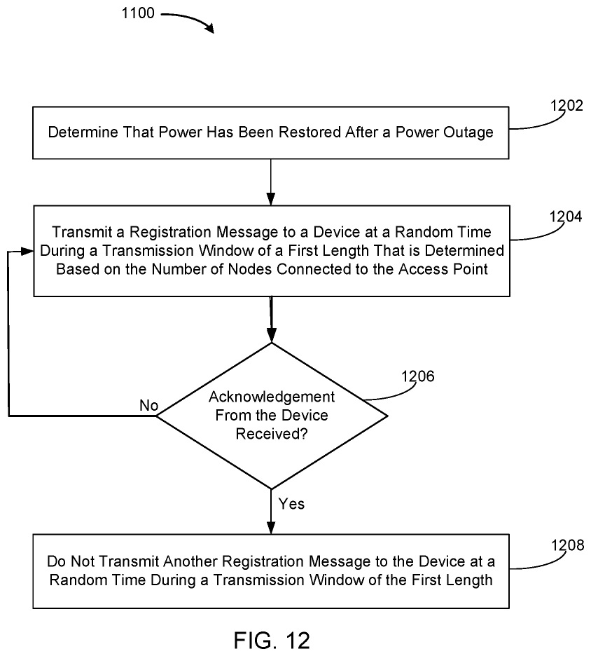

FIG. 12 is a flow diagram of method steps for registering with a device in a constrained network, according to various embodiments. For example, FIG. 12 is a flow diagram of method steps for registering with an access point or a control device in a constrained network. Although the method steps of FIG. 12 are described as being performed by node device 200 using messaging application 216, the method steps of FIG. 12 can also be performed, for example, by first node 102, second node 104, control device 108, control device 900, or some other device connected to a network as described above with respect to FIGS. 1-10. Furthermore, although the method steps are shown in an order, persons skilled in the art will understand that some method steps may be performed in a different order, repeated, and/or performed by components other than those described in FIG. 11.

In some examples, messaging application 216 performs the steps of method 1200 at step 1010 of method 1000 and/or at step 1110 of method 1100. For example, messaging application 216 can implement method 1200 to transmit, at step 1010 of method 1000, one or more third messages to a control device based on one or more operating parameters that were determined at step 1008 of method 1000. As another example, messaging application 216 can implement method 1200 to transmit, at step 1110 of method 1100, one or more third messages to a control device based on the values of one or more operating parameters that were configured, or set, at step 1108 of method 1100.

As shown, method 1200 begins at step 1202, where messaging application 216 determines that power has been restored to node device 200 after a power outage has occurred. For example, messaging application 216 determines that mains-power has been reconnected to power supply 208 of node device 200 and/or a battery included in power supply 208 of node device 200 has been recharged to at least a minimum charge threshold.

At step 1204, messaging application 216 transmits a registration message to a device, such as an access point 106 or a control device 900. At a random time during a transmission window of a first length that is determined based on the number of nodes connected to the access point to which node device 200 is or was connected (e.g., access point 106). For example, messaging application 216 transmits, via access point 106, a PRN to control device 900 to reconnect, or register, with control device 900 after power has been restored. As another example, messaging application 216 transmits a registration message to access point 106 to reconnect, or register, with access point 106 after power has been restored. In one example, messaging application 216 determined, using one or more configuration tables 220 and/or equations and/or algorithms 222, the first length of the transmission window at step 1008 of method 1000 based on the number of node devices that are connected to access point 106. As another example, messaging application 216 determined the first length of the transmission window to be the value of the transmission window length that is defined in one or more operating parameters 218 of node device 200.

At step 1206, messaging application 216 determines whether an acknowledgment message from the device has been received. For example, messaging application 216 determines whether messaging application 216 has received an acknowledgment message from the device (e.g., access point 106 or control device 900) within a certain amount of time (e.g., 1 minute, 5 minutes, 30 minutes, etc.) after transmitting the registration message at step 1204. The acknowledgement message indicates that the device has received the registration message transmitted at step 1204 and that node device 200 is reconnected, or registered, with the device. For example, the acknowledgment indicates that node device 200 is reconnected with access point 106 and/or control device 900.

If, at step 1206, messaging application 216 determines that an acknowledgement message from the device has been received, method 1200 proceeds to step 1208 at which messaging application 216 does not transmit another registration message to the device at a random time during a transmission window of the first length. However, if messaging application 216 determines that an acknowledgement message from the device has not been received at step 1206, method 1200 returns to step 1204 at which messaging application 216 transmits another registration message to the device at a random time within a transmission window of the first length.

### System Overview

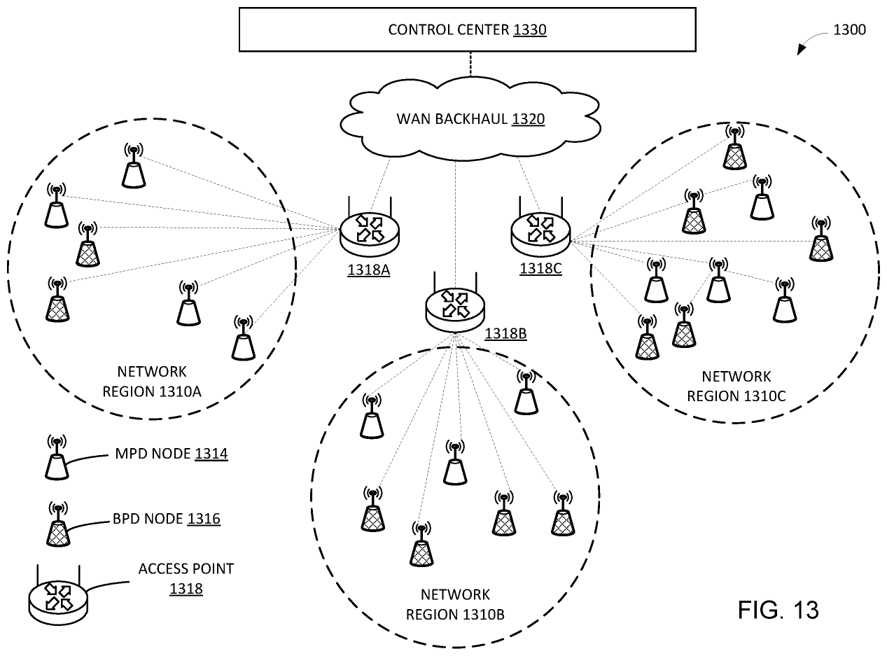

FIG. 13 illustrates a network system configured to implement one or more aspects of the various embodiments. Network system 1300 is, for example, a constrained network such as a Cat-M1 network or an NB-IoT network. Network system 1300 includes one or more network regions 1310, a wide area network (WAN) backhaul 1320, and a control center 1330 that coordinates operation of node devices in the one or more network regions 1310.

In the illustrated example of FIG. 13, the one or more network regions 1310 include a first network region 1310A, a second network region 1310B, and a third network region 1310C. Each of network regions 1310A, 1310B, and 1310C includes various network devices including one or more mains-powered device (MPD) nodes 1314 and/or one or more battery-powered device (BPD) nodes 1316. Any of the one or more MPD nodes 1314 or the BPD nodes 1316 can be used to implement the techniques discussed above with respect to FIGS. 1-11. In various embodiments, first node 102, second node 104, control device 108, node device 200, and control device 900 are implemented as node 1314 or 1316. MPD nodes 1314 draw power from an external power source, such as mains-power or a power grid. MPD nodes 1314 typically operate on a continuous basis without powering down for extended periods of time. BPD nodes 1316 draw power from an internal power source, such as a battery. BPD nodes 1316 typically operate intermittently and power down, or go into very low power mode, for extended periods of time in order to conserve battery power.

Network system 1300 further includes one or more access points 1318 that connect respective MPD nodes 1314 and/or BPD nodes 1316 in the one or more network regions 1310 to control center 1330 via WAN backhaul 1320. In the illustrated example of FIG. 13, the one or more access points 1318 include a first access point 1318A, a second access point 1318B, and a third access point 1318C. First access point 1318A connects the one or more MPD nodes 1314 and/or BPD nodes 1316 in first network region 1310A to control center 1330 via WAN backhaul 1320. Similarly, second access point 1318B connects the one or more MPD nodes 1314 and/or BPD nodes 1316 in second network region 1310B to control center 1330 via WAN backhaul 1320 and third access point 1318C connects the one or more MPD nodes 1314 and/or BPD nodes 1316 in third network region 1310C to control center 1330 via WAN backhaul 1320. In various embodiments, access point is implemented as one or more access points 1318. Furthermore, in various embodiments, one or more of access points 1318 can be implemented as one or more of a sector antenna located at a cellular base station, a wireless access point, a router, a gateway, a transceiver, or some other type of network device that enables nodes to connect to devices in network system 1300. In some embodiments, access points 1318 are implemented as nodes, such as MPD nodes or BPD nodes.

In one example, first access point 1318A, second access point 1318B, and third access point 1318C are implemented as respective sector antennas located at a cellular base station. In this example, first network region 1310A is a first cell sector emanating from first access point 1318A, second network region 1310B is a second cell sector emanating from second access point 1318B, and third network region 1310C is a third cell sector emanating from third access point 1318C. Furthermore, in this example, network system 1300 is a cellular network such as a Cat-M1 network or an NB-IoT network.

In some examples, any of MPD nodes 1314, BPD nodes 1316, and/or access points 1318 are configured to communicate directly with one or more adjacent nodes via bi-directional communication links. The communication links can be wired or wireless links, although in practice, adjacent nodes of a given network region 1310 exchange data with one another by transmitting data packets via wireless radio frequency (RF) communications. In some examples, an MPD node 1314 and/or a BPD node 1316 can connect to an access point 1318 via one or more intermediate nodes. For example, as shown with respect to network region 1310C, MPD nodes 1314 and BPD nodes 1316 can connect to access point 1318C via intermediate MPD nodes 1314 and BPD nodes 1316. In some examples, a node 1314, 1316 connects to another node 1314, 1316 using a first communication protocol and connects to an access point 1318 using a second communication protocol.

A node can transmit, via a given access point 1318 to which the node is connected, data packets and/or messages that contain data packets across WAN backhaul 1320 to control center 1330. Similarly, control center 1330 can transmit data packets and/or messages that contain data packets across WAN backhaul 1320 to a particular node via a given access point 1318 to which the particular node is connected.

In some examples, MPD nodes 1314 and BPD nodes 1316 are implemented as utility metering devices that are coupled to, or included within, a utility distribution infrastructure (not shown) that distributes a resource and/or utility commodity to consumers. In such examples, MPD nodes 1314 and BPD nodes 1316 gather sensor data related to the distribution of the resource and/or utility commodity, gather sensor data related to the consumption of the resource and/or utility commodity, process the sensor data, and communicate processing results and other information to control center 1330 via access points 1318.

Control center 1330 includes one or more server machines (not shown) configured to operate as sources for, or destinations of, data packets and/or messages that traverse within network system 1300. The server machines can query nodes within network system 1300 to obtain various data, including raw or processed sensor data, power consumption data, node/network throughput data, status information, and so forth. The server machines can also transmit commands and/or program instructions to any node within network system 1300 to cause those nodes to perform various operations. In one embodiment, each server machine is a computing device configured to execute, via a processor, a software application stored in a memory to perform various network management operations. In various embodiments, control device 108 and/or control device 900 are included in control center 1330.

1. In some embodiments, a method comprises establishing, at a first node, a connection with an access point; transmitting, by the first node to a control device, a first message that identifies the access point; receiving, by the first node from the control device, a second message that includes a number of nodes connected to the access point; determining, by the first node, an operating parameter of the first node based on the number of nodes connected to the access point; and transmitting, by the first node to the control device and based on the operating parameter, a third message.

2. The method of clause 1, wherein the operating parameter is a number of times to transmit the third message.

3. The method of clauses 1 or 2, wherein determining the operating parameter of the first node based on the number of nodes connected to the access point comprises using, by the first node, a configuration table or an equation to determine the number of times to transmit the third message.

4. The method of any of clauses 1-3, wherein the number of times to transmit the third message includes a whole number and a fractional number; and wherein determining the operating parameter of the first node based on the number of nodes connected to the access point comprises using, by the first node, a weighted random selection based on the whole number and the fractional number to determine a whole number of times to transmit the third message.

5. The method of any of clauses of 1-4, wherein the operating parameter is a length of a transmission window during which the first node transmits the third message.

6. The method of any of clauses 1-5, wherein determining the operating parameter of the first node based on the number of nodes connected to the access point comprises using, by the first node, a configuration table to determine the length of the transmission window.

7. The method of any of clauses 1-6, wherein transmitting the third message based on the operating parameter comprises transmitting, by the first node to the control device, the third message at a random time during a transmission window of the length of the transmission window.

8. The method of any of clauses 1-7, wherein the third message indicates that a power outage has occurred.

9. The method of any of clauses 1-8, wherein the third message indicates that power has been restored after a power outage has occurred.

10. In some embodiments, one or more non-transitory computer-readable media storing instructions which, when executed by one or more processors of a first communication device, cause the one or more processors to perform operations comprising establishing a connection with an antenna; transmitting, to a server via the antenna, a first message that indicates that the first communication device is connected to the antenna; receiving, from the server via the antenna, a second message that includes first information that is based on a number of communication devices that are connected to the antenna; adjusting a transmission behavior of the first communication device based on the first information included in the second message; and transmitting, via the antenna and based on the transmission behavior, a third message.

11. The one or more non-transitory computer readable media of clause 10, wherein the transmission behavior includes a number of times that the first communication device transmits the third message.

12. The one or more non-transitory computer readable media of clauses 10 or 11, wherein the first information includes a count of the number of communications devices that are connected to the antenna.

13. The one or more non-transitory computer readable media of any of clauses 10-12, wherein the first information includes a value of an operating parameter associated with the transmission behavior of the first communication device.

14. The one or more non-transitory computer readable media of any of clauses 10-13, wherein the transmission behavior includes a duration of a transmission window.

15. The one or more non-transitory computer readable media of any of clauses 10-14, wherein the third message includes a notification that power has been restored after a power outage has occurred.

16. The one or more non-transitory computer readable media of any of clauses 10-15, wherein the operations further comprise determining that power has been restored after a power outage has occurred; and in response to determining that the power has been restored, transmitting, to the server via the antenna, the third message at a random time during a transmission window of the duration.

17. In some embodiments, a network device comprising one or more processors; and a memory storing executable instructions that, when executed by the one or more processors, causes the one or more processors to connect to a cellular base station; transmit, via the cellular base station, a first message to a control device that identifies the cellular base station; receive a second message from the control device that indicates a number of network devices that are connected to the cellular base station; adjust an operating parameter based on the number of network devices that are connected to the cellular base station; and in response to an occurrence of a trigger event, transmit, via the cellular base station and based on the operating parameter, a third message to the control device.

18. The network device of clause 17, wherein the network device is powered by mains-power.

19. The network device of clauses 17 or 18, wherein the trigger event is a scheduled time to transmit metrology data or a scheduled time to transmit billing information.

20. The network device of any of clauses 17-19, wherein the trigger event is a power outage or a restoration of power after a power outage has occurred.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow. Moreover, in the above description, numerous specific details are set forth to provide a more thorough understanding of the various embodiments. However, it will be apparent to one skilled in the art that the inventive concepts may be practiced without one or more of these specific details.

What is claimed is:

1. A method comprising:
establishing, at a first node, a connection with an access point;
transmitting, by the first node to a control device, a first message that identifies the access point;
receiving, by the first node from the control device, a second message that includes a number of nodes connected to the access point;
determining, by the first node, an operating parameter of the first node based on the number of nodes connected to the access point; and
transmitting, by the first node to the control device and based on the operating parameter, a third message.

2. The method of claim 1, wherein the operating parameter is a number of times to transmit the third message.

3. The method of claim 2, wherein determining the operating parameter of the first node based on the number of nodes connected to the access point comprises using, by the first node, a configuration table or an equation to determine the number of times to transmit the third message.

4. The method of claim 2, wherein the number of times to transmit the third message includes a whole number and a fractional number; and
wherein determining the operating parameter of the first node based on the number of nodes connected to the access point comprises using, by the first node, a weighted random selection based on the whole number and the fractional number to determine a whole number of times to transmit the third message.

5. The method of claim 1, wherein the operating parameter is a length of a transmission window during which the first node transmits the third message.

6. The method of claim 5, wherein determining the operating parameter of the first node based on the number of nodes connected to the access point comprises using, by the first node, a configuration table to determine the length of the transmission window.

7. The method of claim 5, wherein transmitting the third message based on the operating parameter comprises transmitting, by the first node to the control device, the third message at a random time during a transmission window of the length of the transmission window.

8. The method of claim 1, wherein the third message indicates that a power outage has occurred.

9. The method of claim 1, wherein the third message indicates that power has been restored after a power outage has occurred.

10. One or more non-transitory computer-readable media storing instructions which, when executed by one or more processors of a first communication device, cause the one or more processors to perform operations comprising:
establishing a connection with an antenna;
transmitting, to a server via the antenna, a first message that indicates that the first communication device is connected to the antenna;
receiving, from the server via the antenna, a second message that includes first information that is based on a number of communication devices that are connected to the antenna;
adjusting a transmission behavior of the first communication device based on the first information included in the second message; and
transmitting, via the antenna and based on the transmission behavior, a third message.

11. The one or more non-transitory computer readable media of claim 10, wherein the transmission behavior includes a number of times that the first communication device transmits the third message.

12. The one or more non-transitory computer readable media of claim 10, wherein the first information includes a count of the number of communications devices that are connected to the antenna.

13. The one or more non-transitory computer readable media of claim 10, wherein the first information includes a value of an operating parameter associated with the transmission behavior of the first communication device.

14. The one or more non-transitory computer readable media of claim 10, wherein the transmission behavior includes a duration of a transmission window.

15. The one or more non-transitory computer readable media of claim 14, wherein the third message includes a notification that power has been restored after a power outage has occurred.

16. The one or more non-transitory computer readable media of claim 15, wherein the operations further comprise:
determining that power has been restored after a power outage has occurred; and
in response to determining that the power has been restored, transmitting, to the server via the antenna, the third message at a random time during a transmission window of the duration.

17. A network device, comprising:
one or more processors; and
a memory storing executable instructions that, when executed by the one or more processors, cause the one or more processors to:
connect to a cellular base station;
transmit, via the cellular base station, a first message to a control device that identifies the cellular base station;
receive a second message from the control device that indicates a number of network devices that are connected to the cellular base station;
adjust an operating parameter based on the number of network devices that are connected to the cellular base station; and
in response to an occurrence of a trigger event, transmit, via the cellular base station and based on the operating parameter, a third message to the control device.

18. The network device of claim 17, wherein the network device is powered by mains-power.

19. The network device of claim 17, wherein the trigger event is a scheduled time to transmit metrology data or a scheduled time to transmit billing information.

20. The network device of claim 17, wherein the trigger event is a power outage or a restoration of power after a power outage has occurred.
